(19) United States
(12) Patent Application Publication
(10) Pub. No.: US 2017/0053244 A1
(43) Pub. Date: Feb. 23, 2017

(54) AUTOMATED, INTEGRATED AND COMPLETE COMPUTER PROGRAM/PROJECT MANAGEMENT SOLUTIONS STANDARDIZES AND OPTIMIZES MANAGEMENT PROCESSES AND PROCEDURES UTILIZING CUSTOMIZABLE AND FLEXIBLE SYSTEMS AND METHODS

(71) Applicant: Salim B. KHALIL, Riverside, CA (US)

(72) Inventor: Salim B. KHALIL, Riverside, CA (US)

(21) Appl. No.: 15/231,608

(22) Filed: Aug. 8, 2016

Related U.S. Application Data
(60) Provisional application No. 62/208,670, filed on Aug. 22, 2015.

(51) Int. Cl. G06Q 10/10; G06Q 40/08; G06Q 10/06; H04L 29/08; G06Q 30/08

(52) U.S. Cl. CPC G06Q 10/103; H04L 67/1097; G06Q 30/08; G06Q 10/1097; G06Q 10/0639; G06Q 10/06313; G06Q 10/063114; G06Q 40/08; G06Q 50/08

(57) ABSTRACT

Embodiments are computer program product that provides systems and methods as a complete solution for management profession from initiation to closeout; complies with industry standards and requirements. Automated functionality through cloud server, standardized combination of database management systems with five web-based user's interfaces; for each organizational tier and for quick and emergency responses. On real time communication, simultaneous functionality of the integrated databases provides ultimate optimization while the unified filing system and document control solution facilitates system integrations of the management knowledge areas. Stakeholders utilize their permitted part(s) of the solutions to manipulate data through shared platform while classified data is saved for internal use. Automatically saving project related data, while synchronization while shifting from offline to online work environment. Public outreach enhancement with a project specific website displays permitted information to allow public search and view projects general information including alerts and status.

### CROSS REFERENCE TO RELATED APPLICATION

This application claims the benefit of Provisional Application Ser. No. 62/208,670 filed Aug. 22, 2015 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

This invention relates to improvements in a computer program. More particularly, the present computer program addresses management knowledge areas and its relation with the management process groups. This invention compiles and integrates all management requirements through several terminal points and allow for full collaboration through real time communication among all project users and other stakeholders. General program or projects management or specific management areas like scope, time, risk, budget, construction, quality and more. Management legacy systems are incomplete, disintegrated and in most cases require middle or intermediate programs to communicate.

Description of Related Art Including Information Disclosed Under 37 CFR 1.97 and 1.98

The world is changing, collaborating and evolving, internet services provided the right media and became the common platform for communication, share knowledge, technologies and enhance developments. Management is the key factor that plays the major role in benefiting from these developments and take it to higher levels. Program and project management profession benefited from these improvements but still lacking a uniform and standard digital applications for their industries.

Projects are getting bigger and more complex, local and international projects are classified as mega, large, medium and small projects. Conventional and traditional management methodologies do not help and cannot keep up with these advancements, several computer programs were introduced to the management market, each one targets a very specific application, some of these computer programs addresses more than one management area but there is no such a program that compiles and integrates all management groups and synchronizes them through the management process on a timely manner.

In the construction industry—our exemplary complex example for the purpose of this invention—these problems become more complex and difficult to manage, the scattered and diversified published computer programs simplify and control some or specific areas of the industry but at the same time add up more complexity to the management processes. Due to the complexity and diversification of the Construction Industry and for the purpose of this Patent registration the Construction Industry is used as an illustrative example. This shall address the ultimate program and the construction project management needs.

In today's construction era, the introduced computer programs handle very specific applications like time and schedule management, document control, office work, communications, planning and drawing and similar. Managers of construction projects usually utilize one or more of these programs and tends usually to mix efforts with conventional and classical means and methods. Risk is always there and different types of claims are always surfacing projects, especially on the medium, large and mega size projects. None, has been developed for the program management.

In today's construction era, the projects delivery methodologies evolved too, typical delivery modules are not efficient to manage these large and mega projects, typical design-bid-build procurements does not answer the need for fast resolutions to development requirements. New, Design-Build, Public-Private-Partnerships, Construction Manager General Contractor, Design-Build-Operate and more modules has been introduced to the industry and proved to be efficient. Traditional management methodologies do not help in these innovative procurements, a need for an optimized, automated Computer program to integrate and standardize the management process and procedures are evolving; this disclosed invention provide the solution in a mobile, customizable, and flexible digital solutions.

This invention recognized existing applications and provides a unique one-stop solution for the management industry and will use the construction industry as an exemplary application example. This innovative invention standardizes and simplify the complex implementation of the management programs and provide an easy to use computerized solution to all users while maintaining the highest accuracy and consistency levels of the processes.

Such integration and simplicity allow all project's team to be on the top of their tasks regardless of their locations, offices, fields, away or nearby may be. Such collaboration assures full control on project's scope, time, budget and provides the highest possible quality to the Owners.

The program—this disclosed invention—does not require any special or sophisticated training for users, typical and common computer knowledge that is available to most individuals are enough to kick-off and start the intended implementation of this program. Special training may be needed for those individuals who carry General and Project Administrator positions and their assistances.

This invention does not eliminate jobs but provides better work environment to enhance productivity and performance, at the same time it allows for faster and more accurate decision making to prevent and/or minimizes potential conflicts and claims toward successful project delivery.

Ownerships, project's culture and one-project one-team principals are administered through the Program/Project management office, unified dashboard system, illustrations, document control and filing system, progress and periodical payments, quality management through control and assurance. The unified construction project management solution provides robust repository documents filing system and allows for real time information process; at the same time this system through its automated features simplifies and eases projects completion and closeout.

Disclosed invention is a computer program product that provides complete solutions for management industries from initiation to closeout and comply with industry standards and requirements. This invention designed to be complete and automated as a replacement of the existing management legacy systems; such systems are incomplete, disintegrated and in most cases require middle or intermediate programs to communicate. This Automated Project Management Method Program invention basically based on the integration and managing Quality, Economy, Schedule, Safety, SWPPP (environmental) and Sustainability elements in each project that allow for a real time data transfer and communication which enhances compliance, minimizes risks and other major factors.

Office computers and remote terminals (devices) through a cloud server allow stakeholders to utilize their part(s) of the solutions and to integrate permitted data through shared platform while keeping classified data for internal use. Based on the member's sole discretion and policies, system administrators maintain full control on privileged access to all stakeholders and users.

Solutions systems provide real time communication, the system automatically saves, integrate and transmit users' data through standardized combination of relational and object oriented database management systems, such system allow for several integrated databases to function simultaneously to achieve full optimization of the management process. Remote terminals working off line have to synchronize their data upon accessing a hot spot (Wi Fi) environment.

Disclosed invention were programmed to provide program/project Planning, Scheduling, tracking and managing Milestones. The system provides work assignments features that facilitate resources management and their work tasks and allocations. The financial system provided with this invention provide complete information and control on program/projects funding and payments.

This disclosed invention can be utilized on a single and/or multiple construction projects and other types of projects to assure better performance in progress measurement and monitoring, enhance planning, ties executing and lead project towards completion and closeout. Risk and Quality management are partly integrated and other management processes groups are addressed separately. Unified filling and document control solution is included and the system integrates with other management programs.

Stakeholders and users can search and enter data, edit and view their permitted parts of the applications in the process of Administering and/or Managing a program or a project. Five users interface types, one interface for each organizational tier and one as the quick response and emergency interface; this interface is set for mobile phones and accessible to all project users. An additional program/project website is included in this invention that displays permitted information to enhance public outreach efforts and to allow public to search and view project's general information including alerts and progress status.

### BRIEF SUMMARY OF THE INVENTION

The basis of this invention is to allow for utilization of the solutions and to provide usable and applicable program that applies on all management requirements, customizable and applicable to all types of industries, in full or in partial. The flexibility and customizability of this invention is an advantage that allow to serve all program and project management needs and requirements regardless of the nature of the Industry itself, same features, methodologies and techniques apply on all. Sections or packages of this program can be used as a standalone application or altogether as integrated and complete project management solutions. These characteristics add to the advantages of this program and allow these solutions to be applicable on several sectors of the management profession and not to be limited to the construction industry applications.

Applying this product on the chosen exemplary example (construction) reflects complexity, diversification and the dynamic management aspects especially when it comes to mega infra structure projects. Diversification and complexity of the construction programs increase based on the procurement and delivery systems of these projects. Multi stakeholders, several standards and specifications, requirements variations, field specific situations and much more, all adds on to the complexity of such management.

The disclosed herein is a computer program product, solutions solves these problems and provides complete solutions system for the management industries to conduct typical program/project management tasks from initiation to closeout. This system benefits from the advanced computer programming and internet services that allow the program to functions by means of typical computer devices like desktops, tablets and mobile cell phones, from office base computers or remotely, all through a cloud server.

Another advantage to this program is to allow for all or any of the stakeholders to utilize their part of the solutions and to integrate all permitted data through a standardized shared platform while keeping other data as an internal use only. Online web application is what all organizations are utilizing for their typical day to day businesses, adding a cloud platform that integrates and synchronizes data with all users' terminals and interfaces through a pre-set and standardized management database that allow for a real time communications and information transmission and sharing.

In these solutions, several user interfaces are pre-defined and classified into five different interfaces, four interface types are set for the General Administrator, Project Administrator, project and remote users. Each interface type of these four is accessible and functional through all computer devices desktops, laptops, tablets, and/or mobile cell phones. An extra interface was specifically designed to enhance the solutions functionalities, it is the quick response and emergency interface. These features were specifically designed for the mobile cell phones and accessible to all users while on the project level of the application. These five different interfaces allow each applicant/user to perform all required duties and tasks with highest possible productivity and lowest errors, all data are automatically saved and transmitted for further correspondences or actions on a timely manner. These solutions allow for office and remote/mobile users to automatically communicate, share and integrate data, reports and all other project documents on a timely manner while all information are automatically classified, communicated and saved on the server's databases.

This disclosed invention meets the mentioned needs and comply with ISO 9000 and the Project Management Institute requirements. Quality and Risk management solution is a major part of this program; due to the functional and requirements similarities between Risk management ISO 31000 and Quality Management ISO 9001 especially when it comes to uncertainty, this program partly integrated the two process groups into one solution.

Quality and risk management integration provide adequate tools to eliminate confusion and to better mitigate risk. The solutions provide clear, common understanding and uniform knowledge on project's quality; in addition to the Communication, Quality and Risk management solution, this disclosed program/solutions address other program/project management process like Integration, Scope, Time, and Cost management groups. Human Resources and procurement management groups are managed at a sectorial section especially dedicated for each stakeholder/organization based on their specific rule and operation.

This program enhances project planning, ties executing with monitoring and controlling and leading project towards completion and closeout through a very specific and automated performance and progress measurement and monitoring solutions. The unified document control and filing solution is another major part of this program that eliminates complexity and enhances compliances.

Specific dashboard for each interface type were designed to ease, simplify utilization of this program and at the same time to prevent interference and miscommunication between departments and stakeholders. To provide better understanding to this program, the project management for the construction industry is used as an example due to its complexity and diversification.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows the Cloud Server Databases block diagram.

FIG. 2 shows the Project Management Office (PMO) Components block diagram.

FIG. 3 shows the Project Management Office (PMO) Components Functions and Relations block diagram.

FIG. 4 shows the Database Functionality block diagram.

FIG. 5 shows the Project Setup flowchart.

FIG. 6 shows the Safety flowchart.

FIG. 7 shows the Uniform Filing System (UFS) Dashboard Document Control flowchart.

FIG. 8 shows the Form Development flowchart.

FIG. 9 shows the Meetings flowchart.

FIG. 10 shows the Submittals flowchart.

FIG. 11 shows the Traffic flowchart.

FIG. 12 shows the Reports flowchart.

FIG. 13 shows the Quality Testing and Records flowchart.

FIG. 14 shows the Change Management flowchart.

FIG. 15 shows the Progress Payment flowchart.

FIG. 16 shows the Non-Conformance Reporting (NCR) flowchart.

FIG. 17 shows the Request for Information (RFI) flowchart.

FIG. 18 shows the Closeout flowchart.

FIG. 19 shows the Auditing flowchart.

FIG. 20 shows the Performance flowchart.

FIG. 21 shows the Tasks Assignment flowchart.

FIG. 22 shows the Progress Schedule, Updates and Look ahead flowchart.

FIG. 23 shows the Notice of Design Change (NDC) flowchart.

FIG. 24 shows the Bidding flowchart.

FIG. 25 shows the Material Test Results Analysis flowchart.

FIG. 26 shows the Punch list flowchart.

FIG. 27 shows the Material Acceptance Release flowchart.

FIG. 28 shows the Inspection Verification flowchart.

### DETAILED DESCRIPTION OF THE INVENTION

### Notation and Nomenclatures

The discussions and details provided reflects the embodiments of the disclosed process and procedures of the program, all figures provide integrated operations of multiple invention that may function as a standalone solutions or integrated as the figures reflect. These figures with the stated block and flow diagrams are used for various embodiments of the present inventions. Embodiments that carried out by a processor under the control of computer readable and computer executable instructions are described more in details on various section of this discussion while he computer readable and executable instructions may reside as an example in the data storage features such as computer device usable/readable volatile memory, such memory shall transfer data to the database center while synchronizing within a Wi-Fi hot spot.

Unless otherwise mentioned or specified specifically all information in this discussions are to be understood as description of the invention as applies to the general management profession, and specifically in this presentation addresses the construction project management as an explicit example. The program, methods and procedure are flexible enough to be customized to suit any other industry without changing the main core of the program or its codes that controlling the process, procedures and methodologies.

Although the mentioned descriptions include many information, specifics and data all should not constructed as limiting the scope of this disclosed invention but has merely providing illustrations of general and some of the prefers embodiments of this disclosed invention, the scope of the invention shall be determined by the entire methodology, the system it provided and the appended claims and their legal equivalents rather than by the illustrative examples and some of the related descriptions as stated in these papers.

Due to the reason that this declared disclosure is composed of several embodiments, solutions (application packages), each package can be applied and function as a standalone applications or integrated in partial or in full as an optimized, integrated and Complete Computer Program Product. Discloses method and system provides digital solutions to the management industries that is Automated Mobile Customizable and flexible.

In addition, it standardizes management process and procedure to assure consistency and accuracy; because it is for program project management profession addressing the construction quality and inspection management procedures; the characteristics and features of this computer program product will stand out and become more apparent while conjoining the drawings with the detailed description of the invention.

General Program Overview:

The computer program product provides digital solutions compromises systems and methods directed to the management professionals and industry to manage programs and projects from initiation to closeout. It is a one-stop solution to utilize as an applicable complete program that works on all management requirements. The preferred embodiments of this invention compromises systems and methods; an integrated, and automated digital solutions for management optimization, that is mobile, customizable and flexible. It is a complete computer program product standardize management processes and procedures.

The drawings are classified into seven groups/categories and figures. The figures are sequenced in numbers accordingly and the figure numbers follow this sequence. Accordingly, all drawings (figures) and related detailed descriptions are tied with reference numbers to indicate elements functionalities and their sequence.

It is appreciated to read through the discussions and to the presented figures as presented for convenience use and not to limit the usage and utilization of this invention, the figures stated the functionality of this program towards utilization and implementation under construction projects as an exemplary example, as follows:

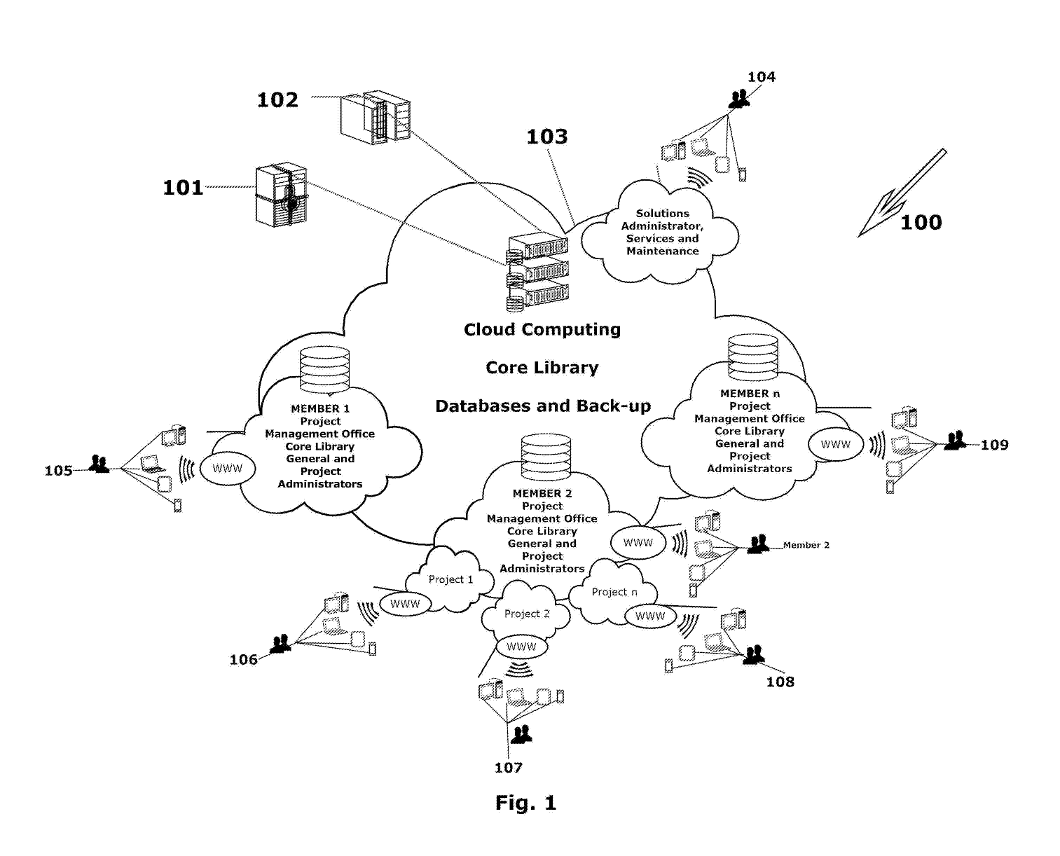

FIG. 1 is a block diagram 100 illustrates the clouds, processor and the server needed to host and control the functionality of this program, project management system according to the pre-defined method as presented in the embodiments of the invention. The master database and the sub-databases are integrated and function as one database center with capability to sub allocate sectors for each member and sub-sectors for each project. In addition, it illustrates the website templates available for each member and one specific website for each project in which shall be utilized for public outreach while executing the project.

This illustration reflects the capabilities of the user to utilize the program through any computer device through an internet access facility either remotely or connected, i.e. on or off-line. The exemplary work environment illustrated in this figure compromise the clouds, processor and server components needed to host and control the functionality of this program. The master database and the sub-databases are integrated and function as one database center with capability to sub allocate sectors for each member and sub-sectors for each project. In addition, it illustrates the website templates available for each member and one specific website for each project in which shall be utilized for public outreach while executing the project. Same illustration reflects the capabilities of the user to utilize the program through any computer device through an internet access facility either remotely or connected, i.e. on or off-line. General administrators shown as 101, and 106 for members 1 and n respectively generate an input through any of their computer devices as long as it contains a processor, memory, input and display devices; such an input is received by the system's databases and feeds back results classified as outputs.

Member's cloud, shown as member 1, member 2 and member n in FIG. 1 represents the members specific cloud which contains the member's virtual server and its links to the mainframe databases and physical backup servers shown as 102 and 103; the backup servers communicate with the master could database shown as 104, while the solutions administrators, services and maintenance team shown as 105, this team provides program versions update and customer support to all members and projects. 101 and 106 represent the members 1 and n clouds while 107, 108, and 109 represent specific projects for member 2 shown as member's 2 project 1, project 2 and project n. Project administrators shown as 107, 108, and 109 may input data and information to expect a feedback and output from the project specific sector of the server while they have a privilege to access the project management office sector of the server for project's backup and support.

All members shown as 1, 2 and n have websites templates shown as (www) in FIG. 1 with an opportunity to develop a project specific website and to be utilized for public outreach team as shown 107, 108 and 109.

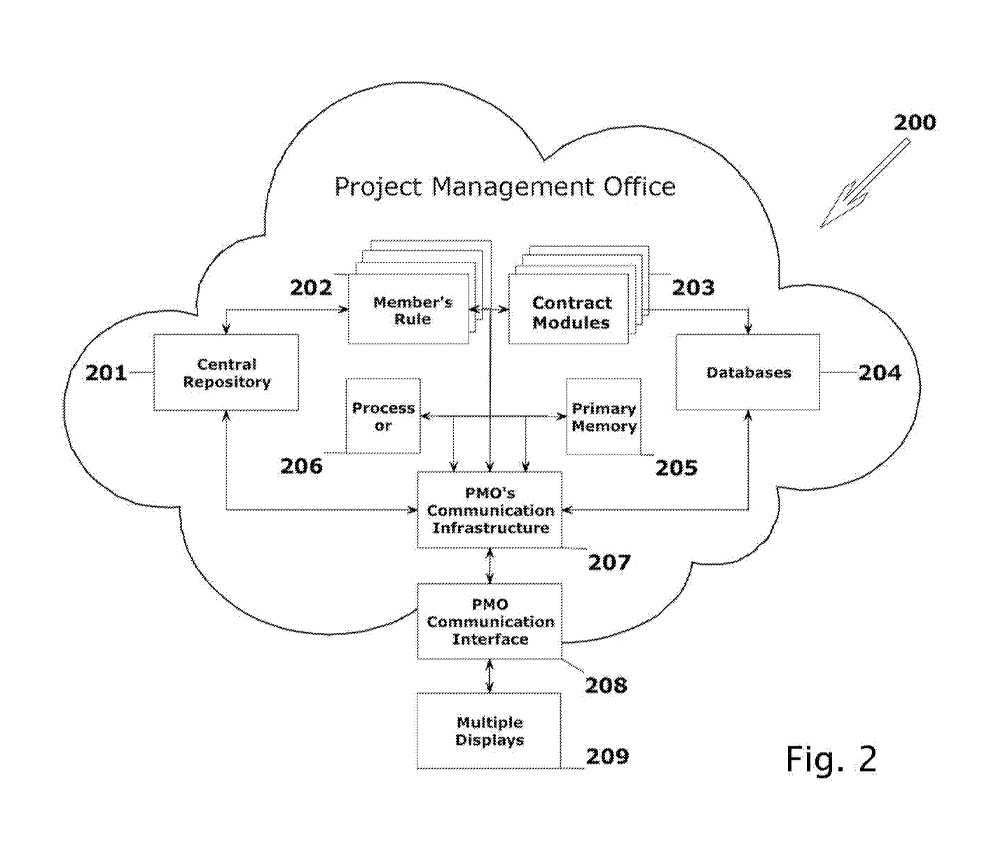

FIG. 2 is a block diagram 200 illustrates the sub-cloud represents the program/Project Management Office (PMO) 200, with its components that is not limited to processors, primary memory, databases, communication infrastructure, communication interfaces and displays and the contract modules, member's rules. All with the central documents and records repository for a member to utilize. These interactive components are resided on a cloud and shown in FIG. 2 as 201 is the member's general administrator's and/or project's administrator's computer devices, while 202, 203, 204, 205, 206, 207 and 209 illustrate the other virtual computing components and devices including the central database management system. In which the general administrator and/or the project administrator jointly or separately can input data and information to receive back results classified as an output of the project management office.

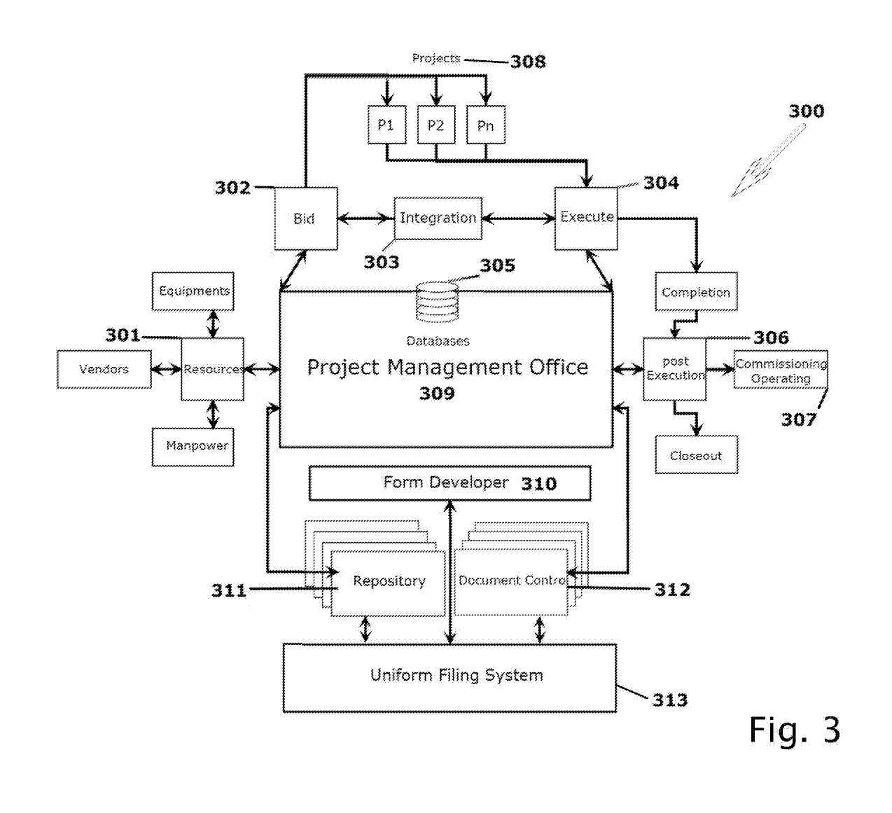

FIG. 3 is a block diagram 300 provides general schematics for the program/Project Management Office (PMO), and its relations though pre, during and after project completion and closeout. The incorporated general flow diagram provides the program/project management office capabilities of providing full support during project execution that is not limited to project Plans, templates, forms, tables and other technical support. In addition, it shows the general bidding processes for several projects and the integration features between bid data and how it is utilized during project execution phase. The post construction support of the project management office goes beyond the closeout and carries over to the commissioning and operating procedures. The resources database section of the program/project management office enriches the bidding support as well as the project performance during execution. All of these services are available and ready to be provided to the projects in all phases and all based on the program/project management repository and its document control feature that is belt on the uniform filing system of the program.

The schematics for the program/project management office as shown in 305 and 312 and its relations though pre, during and after project completion and closeout, as shown in 301, 302, 303, and 306. The incorporated general flow diagram provides the program/project management office capabilities of providing full support during project execution that is not limited to project Plans, templates, forms, tables and other technical support as shown in 307, 308, 309, and 310. In addition, it shows the general bidding processes as shown in 301 and 302, bidding for several projects as shown in 311 and the integration features between bid data and how it is utilized during project execution phase as shown in 304.

The post construction support of the project management office goes beyond the closeout and carries over to the commissioning and operating procedures as shown in 313. The resources database as shown in 301 and 305 section of the program/project management office enriches the bidding support as well as the project performance during execution. All of these services are available and ready to be provided to the projects in all phases and all based on the program/project management repository as shown in 308 and its document control feature as shown in 309 that is belt on the uniform filing system of the program shown in 310.

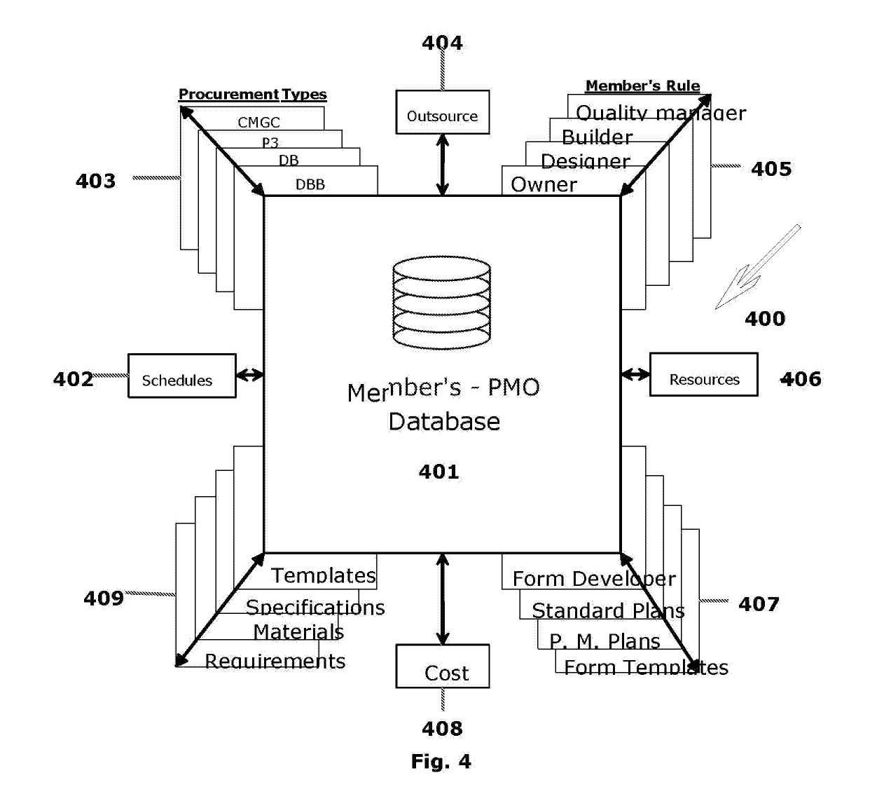

FIG. 4 is a block diagram 400 representing the central database system in the program and the pre-designed packages for project procurement types, member's rule on the project, and contains the backup data for the project standards, specifications, templates, plans and other requirements. In addition, it includes the form developer program that is embedded in this program. Also, this database contains all schedule, resources, outsourcing and cost data and information. This database system functions and support's member's business operations during the day-to-day operations, bidding on projects, while executing, and post completion. IT is the central heart of the program. The central database system as shown in 401 of the program and the pre-designed packages for project procurement types, member's rule on the project as shown in 403 and 405, and contains the backup data for the project standards, specifications, templates, plans and other requirements as shown in 407 and 409. In addition, it includes the form developer program that is embedded in this program and as shown in 407. Also, this database contains all schedule, resources, outsourcing and cost data and information as shown in 402, 404, 406 and 408. This database system functions and support's member's business operations during the day-to-day operations, bidding on new projects, while executing other projects, completing or closing other more, and conducting post completion operations on some other projects too. It is the central heart of the program.

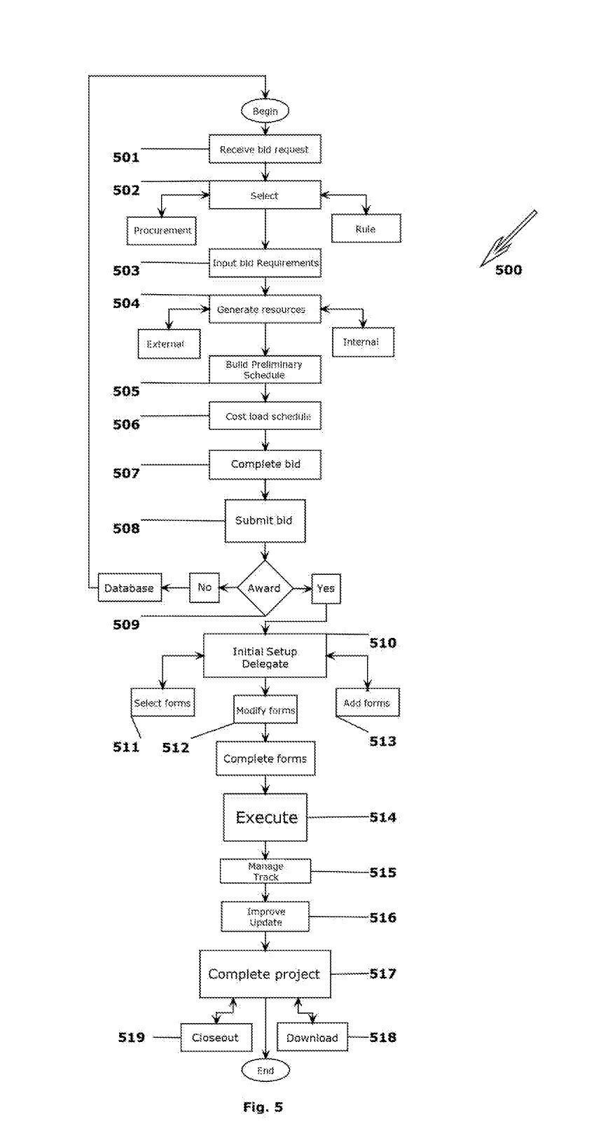

FIG. 5, is a flow diagram 500 illustrates the functionality of the initial project set up while in bidding process and after award, in addition it facilitates the automated bidding tool already embedded in this program. Such setup allows the general administrator to initially setup a project for bidding purposes and after award and delegation to the project administrator to continue the project setup process. The automated bidding tool—software—within the system allows the member to bid on new project utilizing real data and information already stored in the database. Same illustration reflects the bidding processes and features while utilizing the program/project management office features during the pre-bidding process that is not limited to the initial setup of the project but extends that to the project procurement type and member's rule as included.

The initial project set up while in bidding process and after award as shown in the groups from 501 to 509 and 510 to 517. In addition, it facilitates the automated bidding tool already embedded in this program as shown in FIG. 4. Such setup allows the general administrator to initially setup a project for bidding purposes and after award and delegation to the project administrator to continue the project setup process on as needed basis. The automated bidding tool—software—within the system allows the member to bid on new project utilizing real data and information already stored in the database. Same illustration reflects the bidding processes and features while utilizing the program/project management office features during the pre-bidding process that is not limited to the initial setup of the project but extends that to the project procurement type and member's rule selections as included. The figure is self-explanatory and illustrates the functions in two different groups. The dashboard of the program as shown in 708 is the key access point to all mentioned features including the uniform filing system and it related document control system. The complete project 517 ends with a download 518/closeout 519.

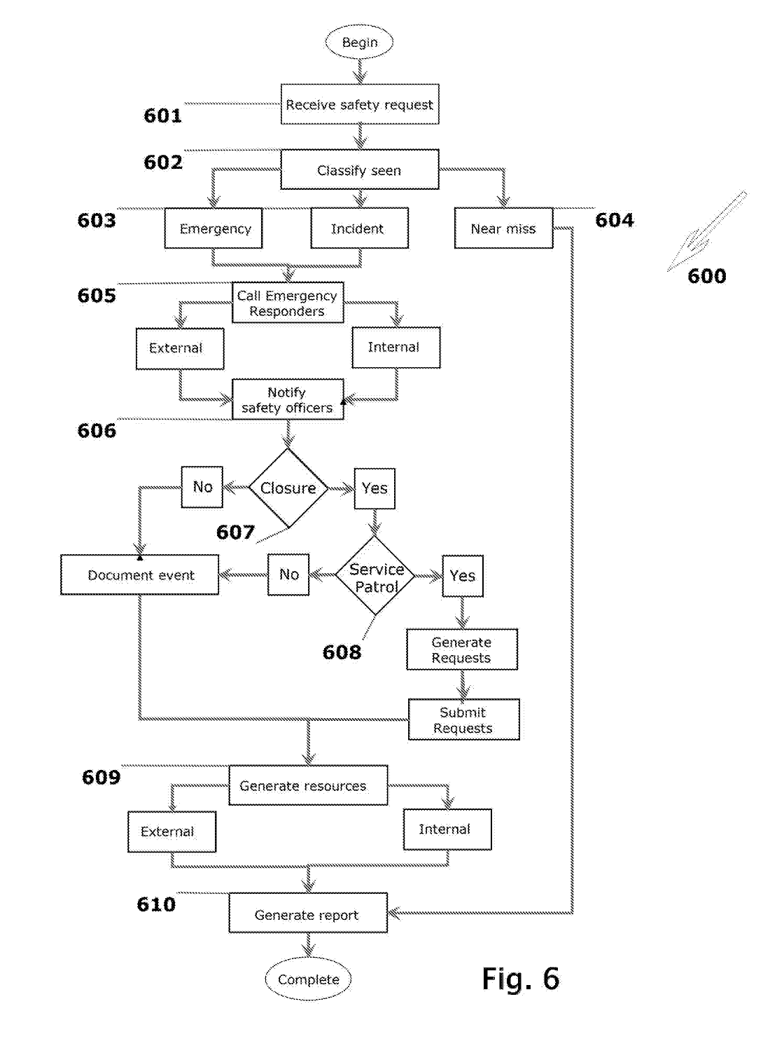

FIG. 6 is a flow diagram 600 illustrates the safety management tools in the program, such is not limited to the automated crises management processes but in addition allows user to act and respond on incidents and to communicate with emergency responders in and outside the project limits, in addition it facilitates the real time reporting procedure for all including the near misses. The safety management tools in the program, such tool is not limited to the automated crises management processes but in addition allows user to act and respond on incidents and to communicate with emergency responders in and outside the project limits, in addition it facilitates the real time reporting procedure for all including the near misses. Such features are self-explanatory as illustrated in FIG. 6 and as shown in 601 to 610.

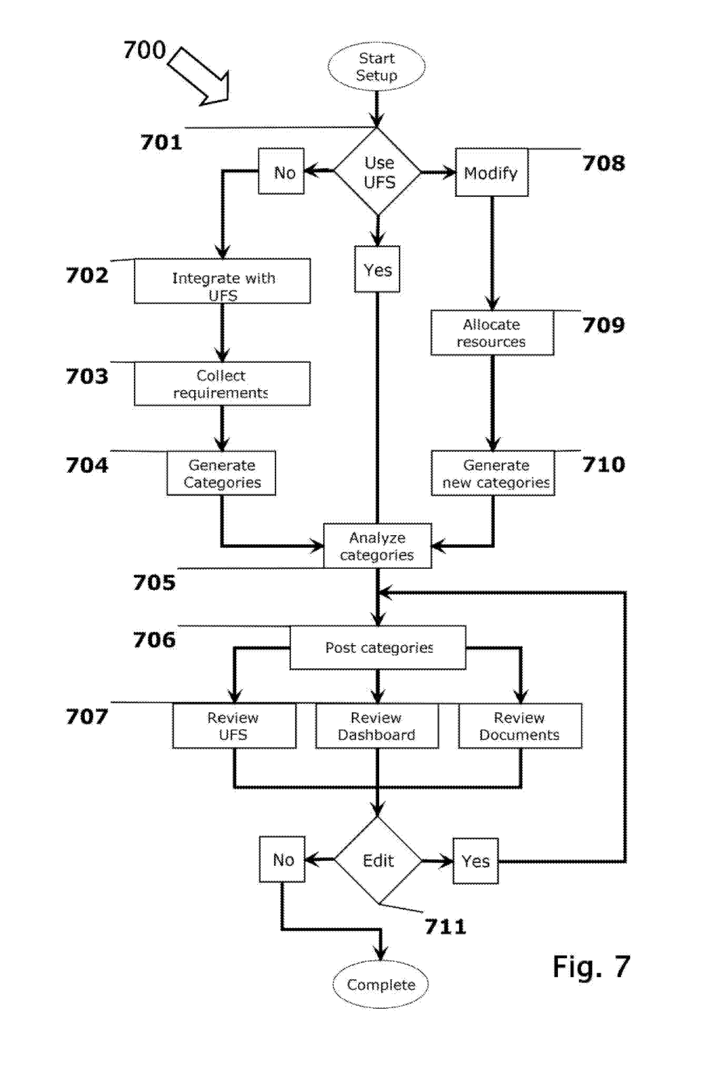

FIG. 7 is a flow diagram 700 illustrates the usage of the embedded Uniform Filing System (UFS) while in the initial project setup phase or more in details about project setup continuation after award which includes subs and setup updates. The project's uniform filing system provides efficient document control and in general project management solution in which all project documents are located and easily accessible through several locations of the program including the direct access through the dashboard of the program. The embedded uniform filing system while in the initial project setup phase as shown in 701, or more in details about project setup continuation after award which includes subs and setup updates.

The project's uniform filing system provides efficient document control and in general project management solution in which all project documents are located and easily accessible through several locations of the program including the direct access through the dashboard of the program. The embodiments of the uniform filing system are flexible and subject for modification as per the project needs. Member's general administrator and/or the project administrator may share the efforts of project setup pre-award for the general administrator and post award for the general administrator. The general administrator may carry this rule along from initial setup to updating if elected not to delegate this task to the project administrator. Sections from 701 to 711 reflects these functions and features as stated in the self-explanatory FIG. 7.

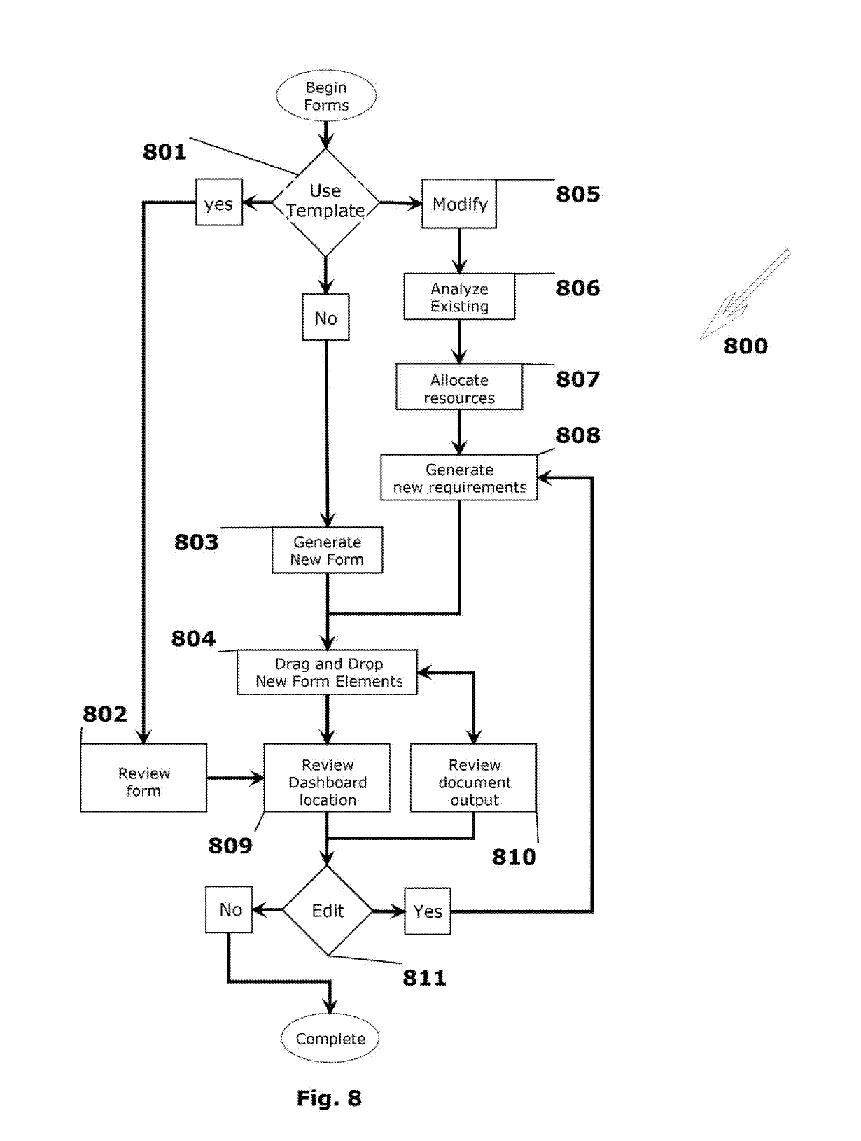

FIG. 8 is a schematic flow diagram 800 presents the form developing capabilities during project setup and in addition allows the project administrator to edit, modify, delete or add new components to any of the project forms utilizing a drag and drop form developing software already embedded in the system. New, modified or edited forms are automatically stored where they belong to in the unified filing system also embedded in the program; i.e. no need to utilize any of the conventional methods like “save as” or to “save it at” or similar. The provided option of using existing templates and presents the form developing capabilities during project setup and in addition allows the project administrator to edit, modify, delete or add new components to any of the project forms utilizing a drag and drop form developing software already embedded in the system. New, modified or edited forms are automatically stored where they belong to in the unified filing system also embedded in the program; i.e. no need to utilize any of the conventional methods like “save as” or to “save it at” or similar. FIG. 8 contains the sequence and the steps of such features from 801 to 806. The flowchart 800 includes the allocation of resources 807, generation of new requirements 808, review of dashboard location 809, review of document output 810 and an editing option 811.

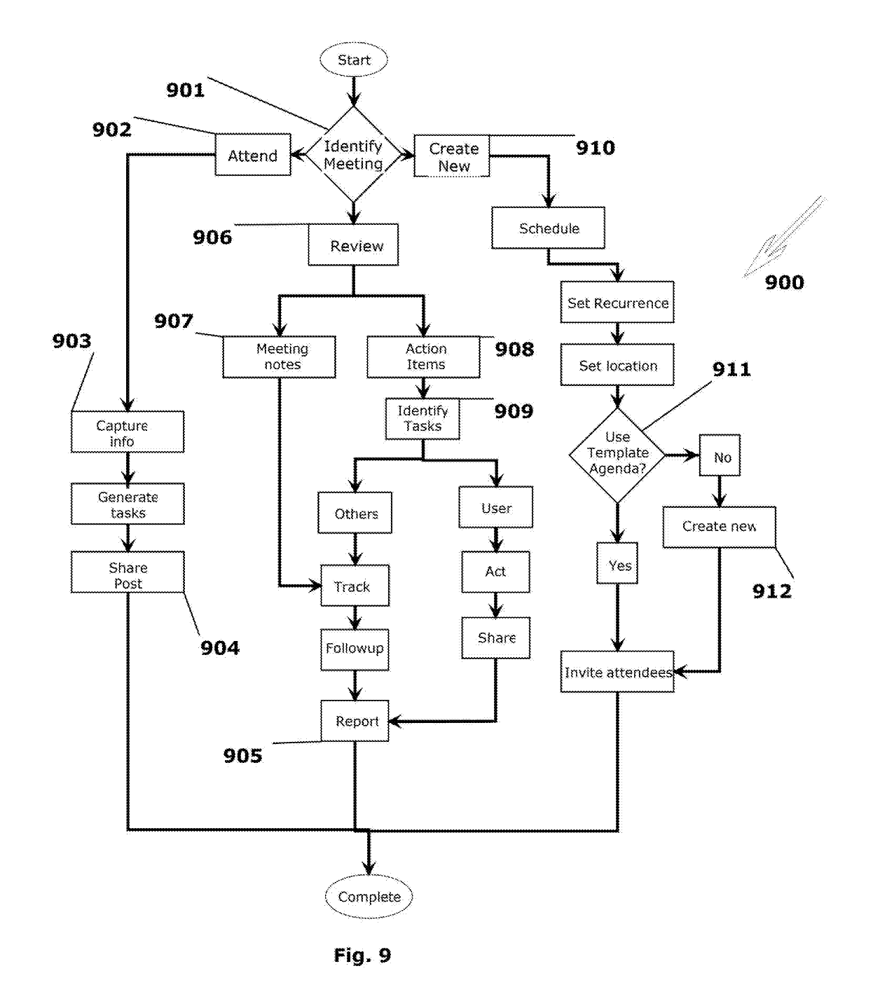

FIG. 9 is a follow diagram 900 representing the meeting management procedure already embedded in this program, it allows the project management to pre-set recurring meeting and to tie attendees to positions and job titles while individual names will be reflected in the documents. In an aspect that an individual has been replaced with another person, the new name—the successor—will show up in the meeting documents. This feature automatically walks user through meeting process to setting up a meeting to act and respond on the actions items resulting from these meetings. At the same time, meeting attendees will have all previous meetings information handy and accessible. Such feature enhances and improves meeting performance and efficiency. The meeting management procedure already embedded in this program as shown in 901 through 912, it allows the project management to pre-set and schedule recurring meetings and to tie attendees to positions and job titles while individual names will be reflected in the documents.

In an aspect, an individual has been replaced with another person, the new name—the successor—will show up in the meeting documents replacing the predecessor's name. This feature automatically walks user through meeting process that includes setting up meetings, act and respond on the actions items resulting from these meetings as shown in 903, 904, 908 and 909 to 905. At the same time, meeting attendees will have all previous meetings information handy and accessible. Such feature enhances and improves meeting performance and efficiency. All meeting notes can be tracked as shown in 907 and 905. The system allows users to use existing meeting agendas templates or to modify or create new.

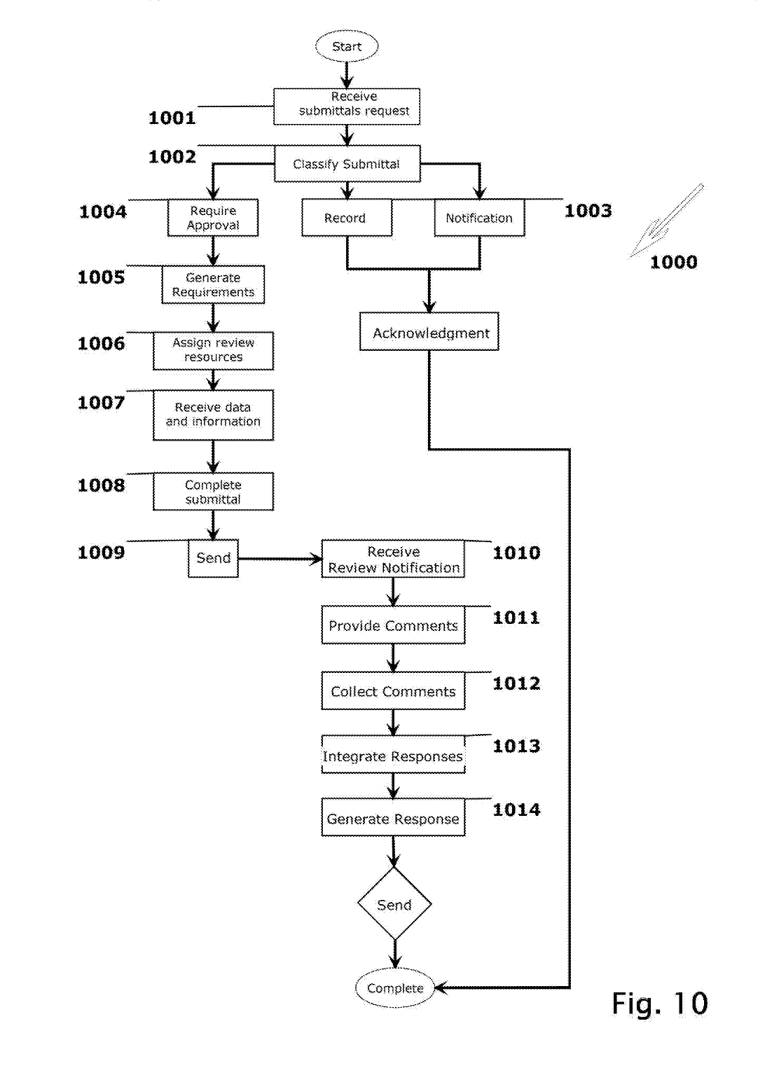

FIG. 10 is a flow diagram 1000 illustrates the automated submittals management and related review and approval process to generate adequate responses on timely manner. All submittals are tied to a metering system that controls time from initiation to response; such feature enhances better project planning and prevents potential time delay claims in the project. At the same time, all engaged personnel will be aware of the submittals progress on timely manner and may enhance over-the-shoulder meetings and discussions while documenting all in the same platform. The automated submittals management and related review and approval process to generate adequate responses on timely manner. All submittals are tied to a metering system that controls time from initiation to response; such feature enhances better project planning and prevents potential time delay claims in the project. At the same time, all engaged personnel will be aware of the submittals progress on timely manner and may enhance over-the-shoulder meetings and discussions while documenting all in the same platform. The self-explanatory processes stated in 1001, 1002, 1003, 1004, 1005, 1006, 1007, 1008, 1009, 1010, 1011, 1012, 1013 and 1014.

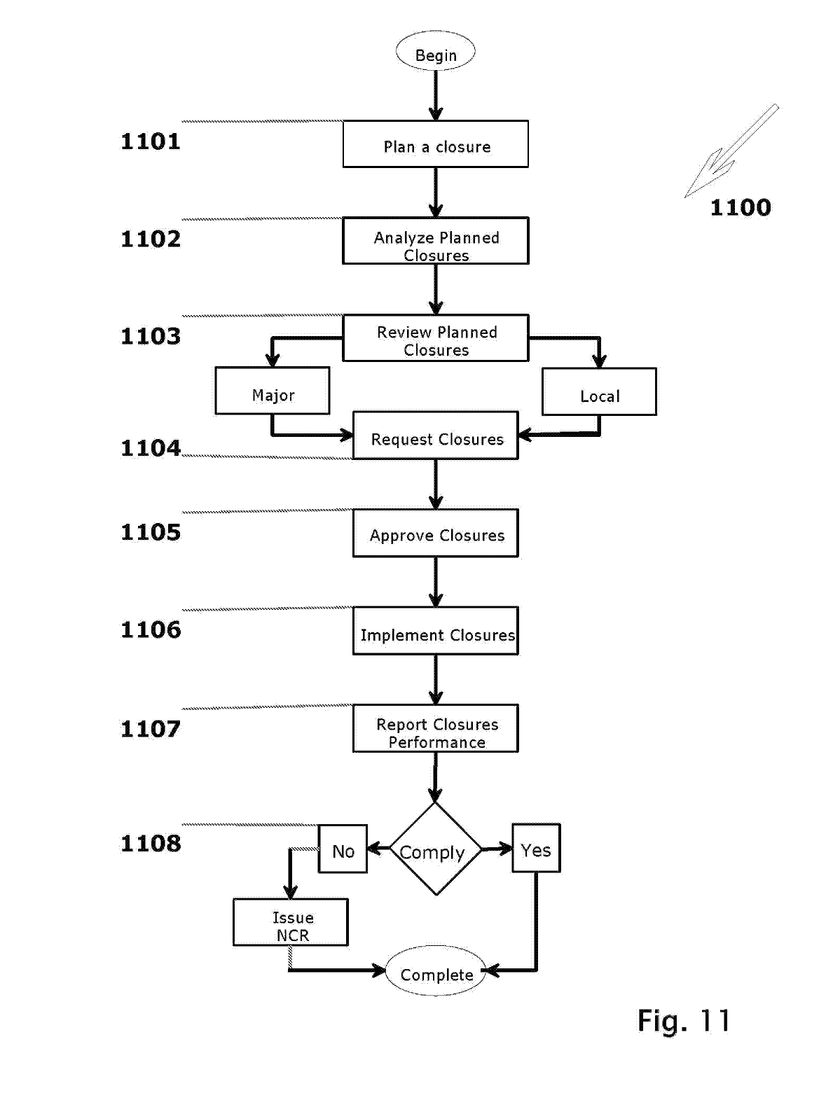

FIG. 11 is a flow diagram 1100 represents the maintenance of traffic in general and controls in a timely and automated manner the traffic control aspects of this management area. Based on the pre-planned work and the need to close a section of the construction site or a roadway the closure can be planned, reviewed and analyzed, classified and requested formally for approval. Such approvals are automatically communicated with field's team to implement the closure as per approved. In case a deficiency or non-conforming a non-conformance report is generated and a deductive change order may be initiated. The maintenance of traffic in general and at the same time controls—in timely and automated manner—the traffic control aspects of this management area. Based on the pre-planned work and the need to close a section of the construction site or a roadway the closure can be planned, reviewed and analyzed, classified and requested formally for approval. Such approvals are automatically communicated with field's team to implement the closure as per approved. In case a deficiency or non-conforming a non-conformance report is generated and a deductive change order may be initiated. Al as shown in 1101, 1102, 1103, 1104, 1105, 1106, 1107 and 1108.

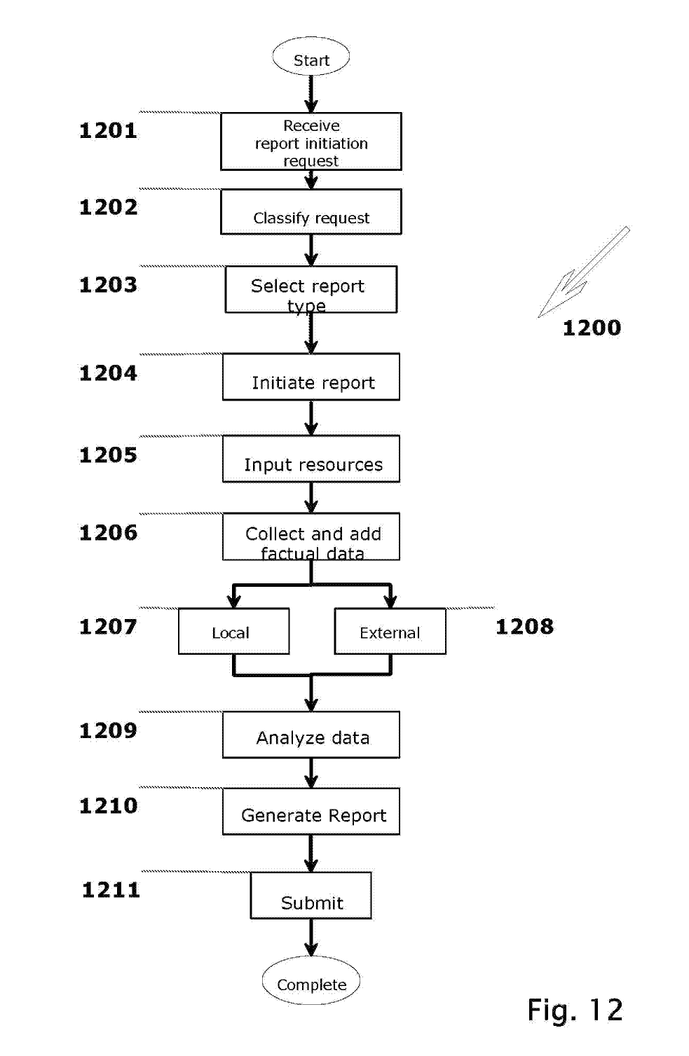

FIG. 12 is a flow diagram 1200 illustrating the automated reporting procedure, such is not limited to field inspection, but exceeds that to any type of inspection or reporting the project is requiring and was assigned during the setting up of the project itself. Such feature differentiates the type and level of reporting based on rule of the user; as an example contractor's reporting is a quality control type and it differs from the quality assurance and the independent quality assurance reporting needs. This feature also allows for an oversight and third party individual to conduct such verification based on their rule and project requirements. The automated reporting procedure, such is not limited to field inspection, but exceeds that to any type of inspection or reporting the project is requiring and was assigned during the setting up of the project itself. Such feature differentiates the type and level of reporting based on rule of the user; as an example contractor's reporting is a quality control type and it differs from the quality assurance and the independent quality assurance reporting needs. This feature also allows for an oversight and third party individual to conduct such verification based on their rule and project requirements. Also, in this figure the process is shown in 1201, 1202, 1203, 1204, 1205, 1206, 1207, 1208, 1209, 1210 and 1211.

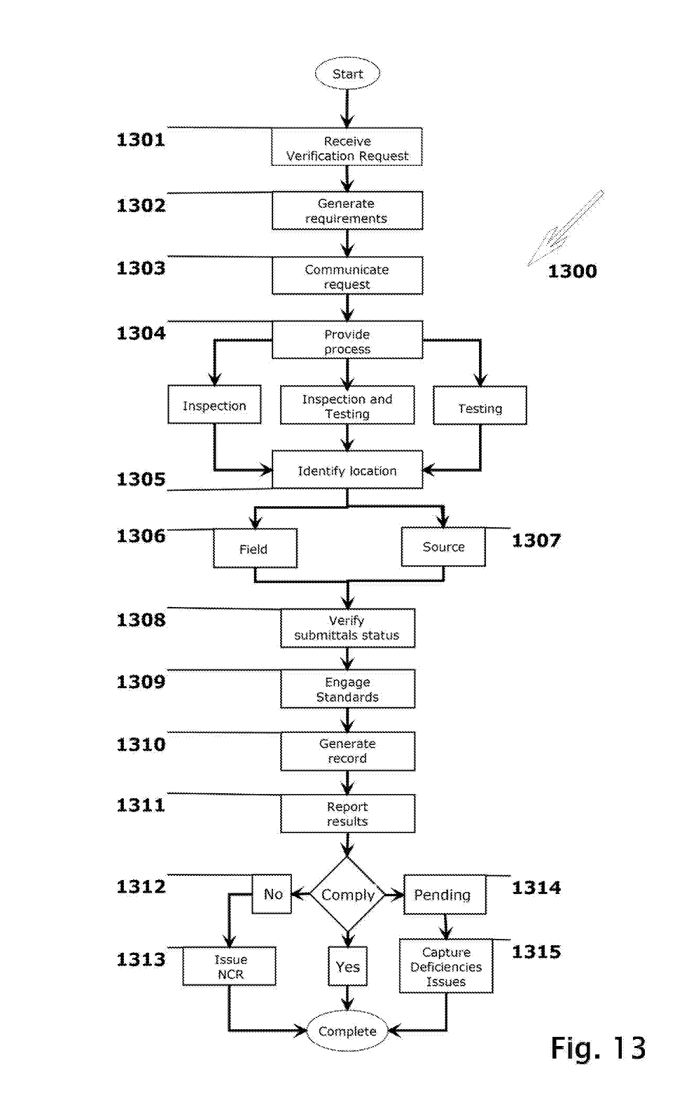

FIG. 13 is a flow diagram 1300 illustrates the quality control and assurance, it is the verification process that is not limited to material inspection and testing in the field or at source, it also facilitates an automated procedure for the inspectors to be aware of the standards and requirements such as approved submittals that is not limited to shop drawings, mix designs or any other necessary document. This feature allows for a real time reporting process and keeps project personnel and management aware of the situation and results on timely manner. The quality control and assurance, it is the verification process that is not limited to material inspection and testing in the field or at the source, it also facilitates an automated procedure for the inspectors to be aware of the standards and the materials requirements such as approved submittals that is not limited to shop drawings, mix designs or any other necessary document. This feature allows for a real time reporting process and keeps project personnel and management aware of the situation and results on timely manner. Such verification, inspection, reporting and releasing is stated in the self-explanatory FIG. 13 and as shown in 1301, 1302, 1303, 1304, 1305, 1306, 1307, 1308, 1309, 1310, 1311, 1312, 1313, 1314 and 1315.

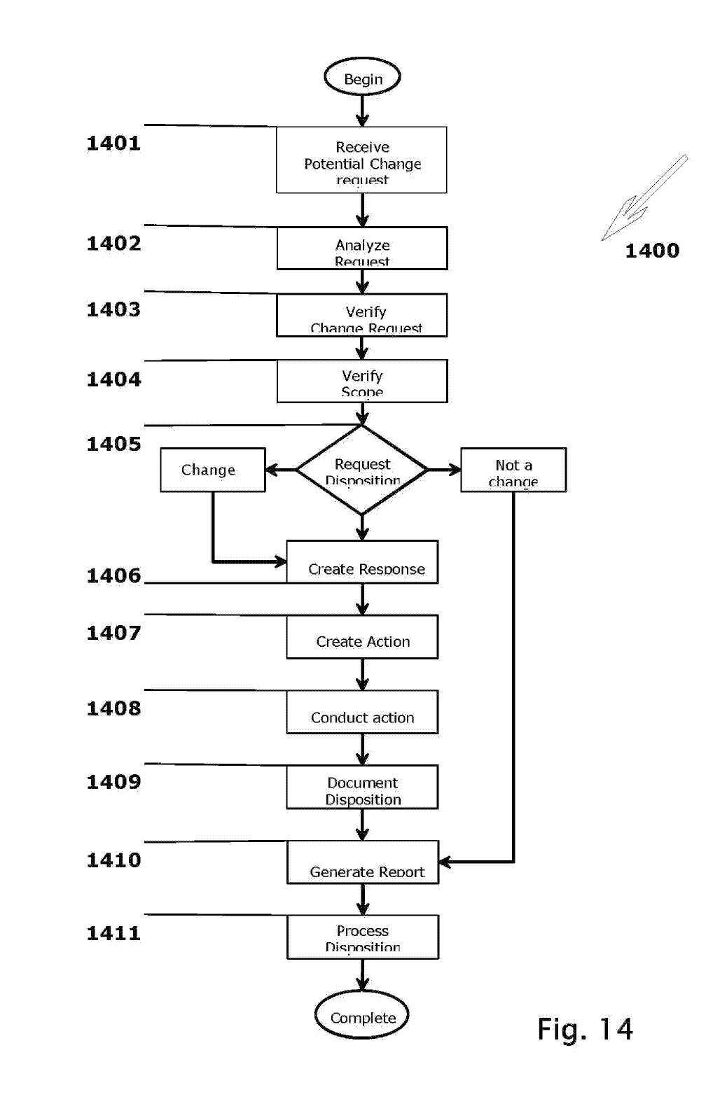

FIG. 14 is a flow diagram 1400 presents general diagram that illustrates the change management process and procedure on a project. Such begins with the potential change request and could be of any type or cause. This automated feature provides spontaneous access to project data and records to better assess the situation and verify if this request is within the scope of the project or not to facilitate thorough and accurate disposition to perform accordingly. The change management process and procedure on a project. Such begins with the potential change request and could be of any type or cause. This automated change management feature provides spontaneous access to project data and records to better assess the situation and verify if this request is within the scope of the project or not to facilitate thorough and an accurate disposition to taken and performed accordingly. The self-explanatory FIG. 14 includes the steps of this feature from 1401 to 1411.

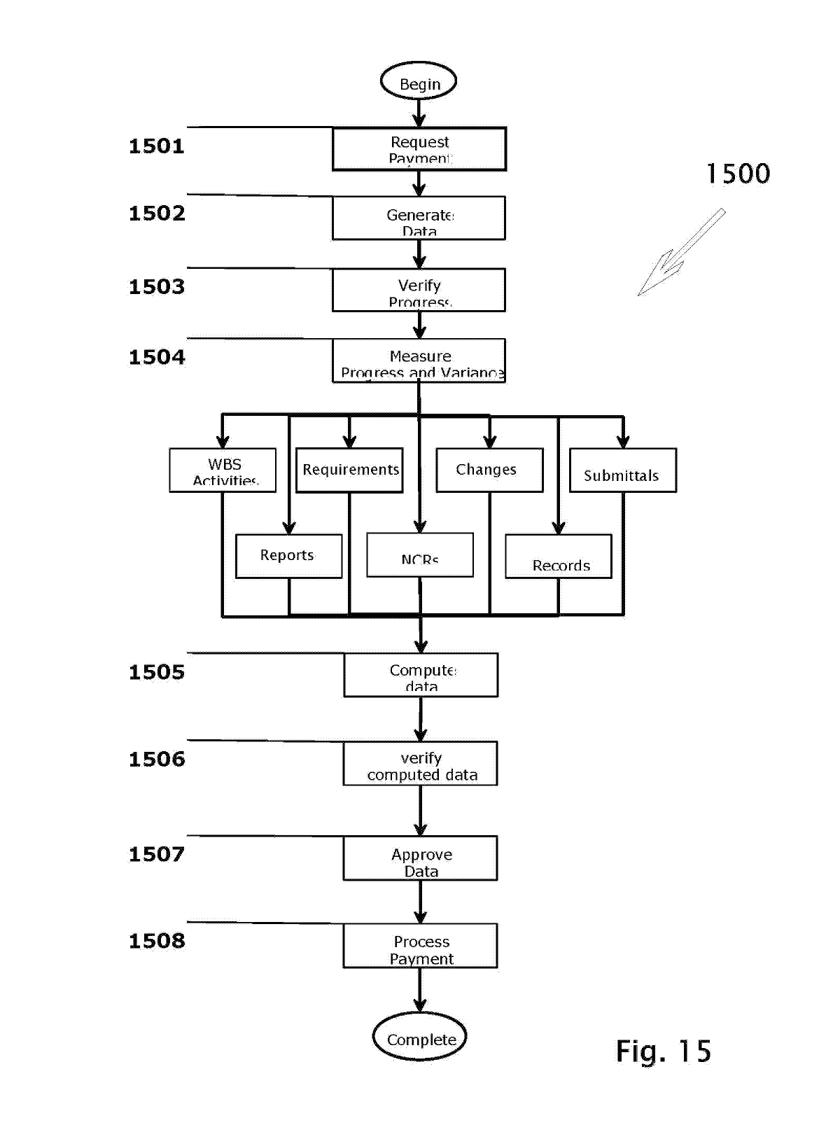

FIG. 15 is a flow diagram 1500 illustrates the progress payments methodologies for any type of procurement, this feature automatically ties the progress payment request to the contract requirements, the changes, the open or non-conforming items of the project. Project's process payment and control features are applicable while in the execution phase; such process and such feature eases the progress payments process and provides accurate payment estimates on timely manner to prevent any disputes or claims. The progress payments methodologies for any type of procurement, this feature automatically ties the progress payment request to the contract requirements, the changes, the open or non-conforming items of the project. Project's process payment and control features are applicable while in the execution phase; such process and such feature eases the progress payments process and provides accurate payment estimates on timely manner to prevent any disputes or claims. Al as shown in 1501, 1502, 1503, 1504, 1505, 1506, 1507 and 1508.

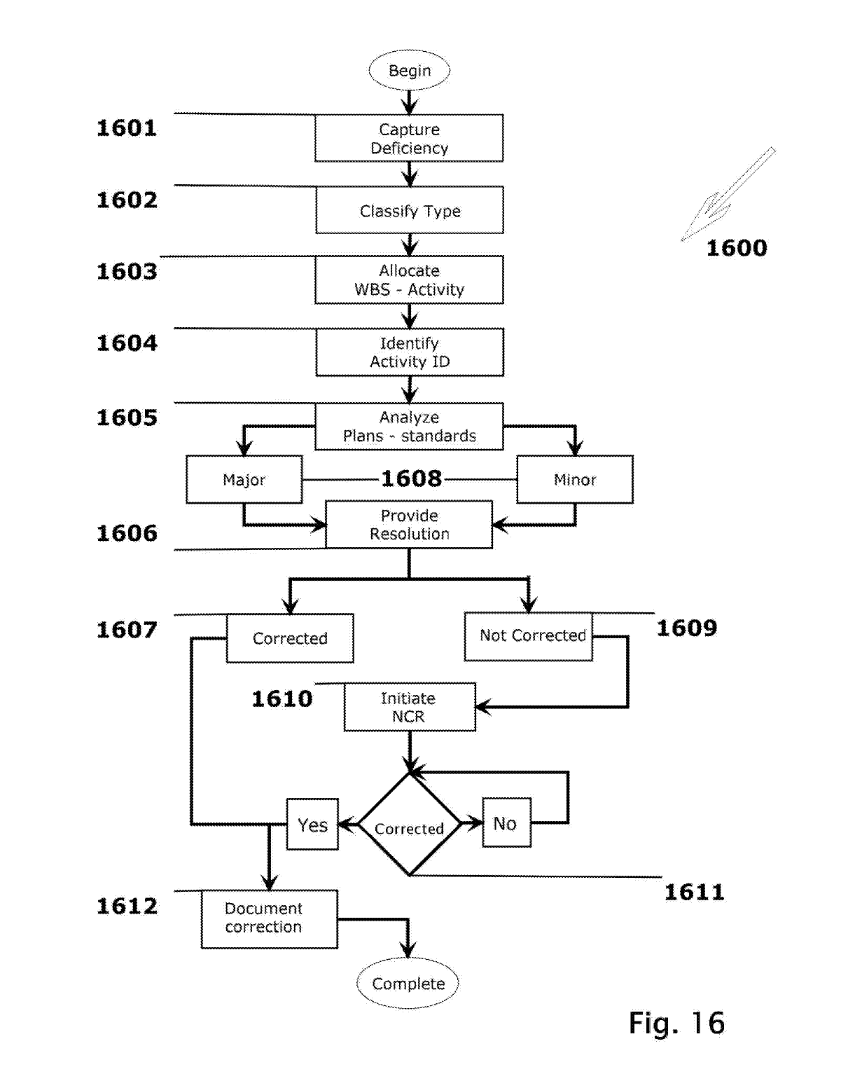

FIG. 16 is a flow diagram 1600 illustrates the non-conformance reporting, that is starting with capturing deficiency as an issue, tie it to the scope and the detailed activity and the related standard and then if not corrected while in progress a Non-Conformance Report (NCR) shall be issued to track corrective actions. The non-conformance reporting, that is starting with capturing an issue, tie it to the scope and the detailed activity and the related standard and then if not corrected while in progress a non-conformance report shall be issued to track corrective actions. As shown in 1601, 1602, 1603, 1604, 1605, 1606, 1607, 1608, 1609, 1610, 1611 and 1612.

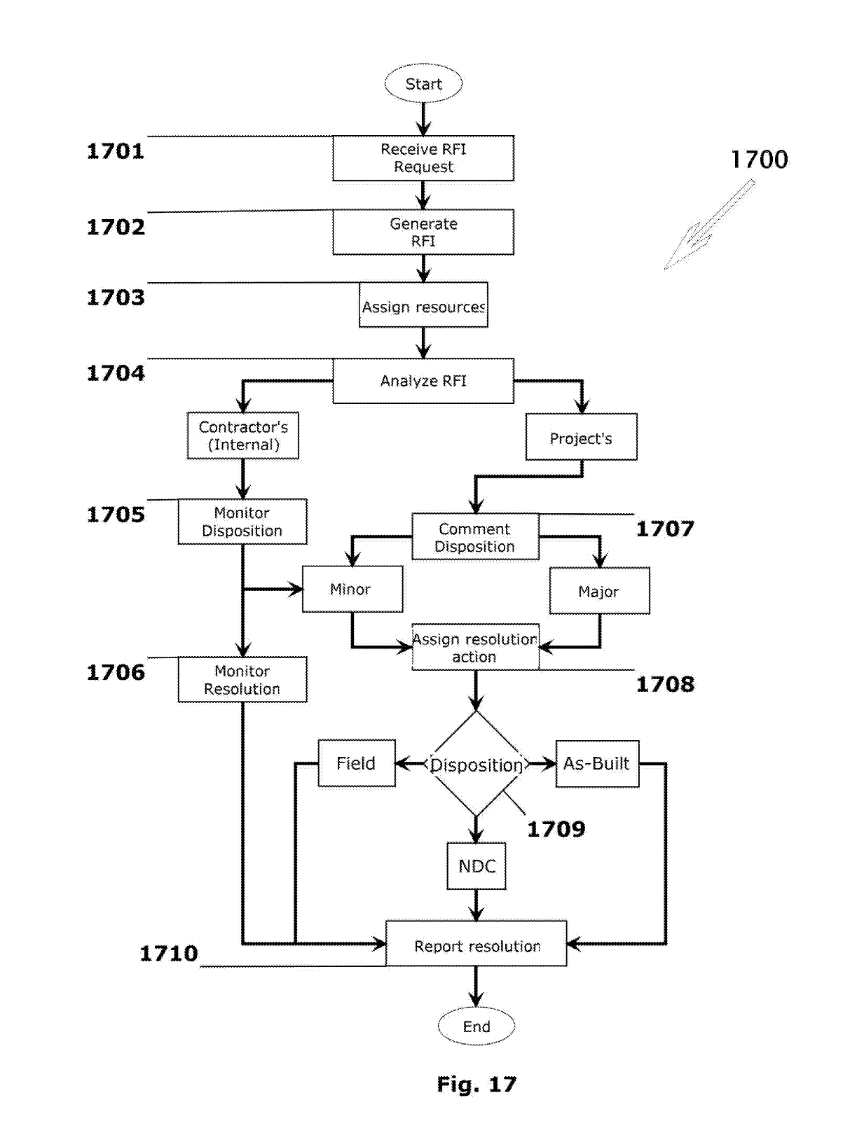

FIG. 17 is a flow diagram 1700 illustrates the Request for Information (RFI) process and procedure, this classifies the RFIs into contractor's and project's, at the same time this reflects the minor and major at the same time. It allows, all responsible personnel to monitor, comment and act on the submitted RFI and disclose in a timely manner, even if it ends with any type of disposition, field, design change, or to document in the as-built drawings. The request for information—RFI—process and procedure, this classifies the RFIs into contractor's and project's as shown in 1701, at the same time this reflects the minor and major at the same time. It allows, all responsible personnel to monitor, comment and act on the submitted RFI and disclose in a timely manner, even if it ends with any type of disposition, field correction, design change, or to document in the as-built drawings. All as stated in FIG. 17 and as shown in 1701, 1702, 1703, 1704, 1705, 1706, 1707, 1708, 1709 and 1710.

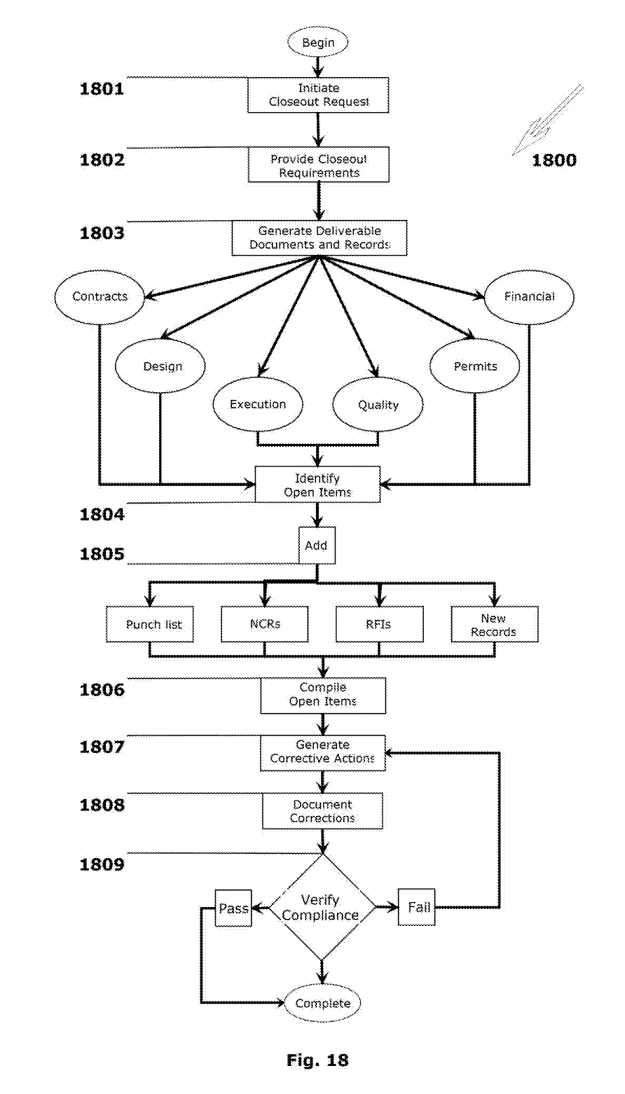

FIG. 18 is a flow diagram 1800 illustrates the automated closeout and its requirements, such process carrier a specific closeout requirements based on the project setup. In the construction industry for example this feature automated the punch list and all other open items and allows the user to create final action items to complete all project documents and records to comply with the needs and to allow for seamless closeout. Such closeout feature allows project management to monitor project records and documents at any time of the project's lifecycle, such will motivate pro-active attitude to comply on as the project progresses.

The automated closeout and its requirements, such process carrier a specific closeout requirements based on the project setup. In the construction industry for example this feature automated the punch list and all other open items and allows the user to create final action items to complete all project documents and records to comply with the needs and to allow for seamless closeout. Such closeout feature allows project management to monitor project records and documents at any time of the project's lifecycle, such will motivate pro-active attitude to comply with the project requirements while the project is in progresses. All as stated in FIG. 18 and as shown in 1801, 1802, 1803, 1804, 1805, 1806 and 1809.

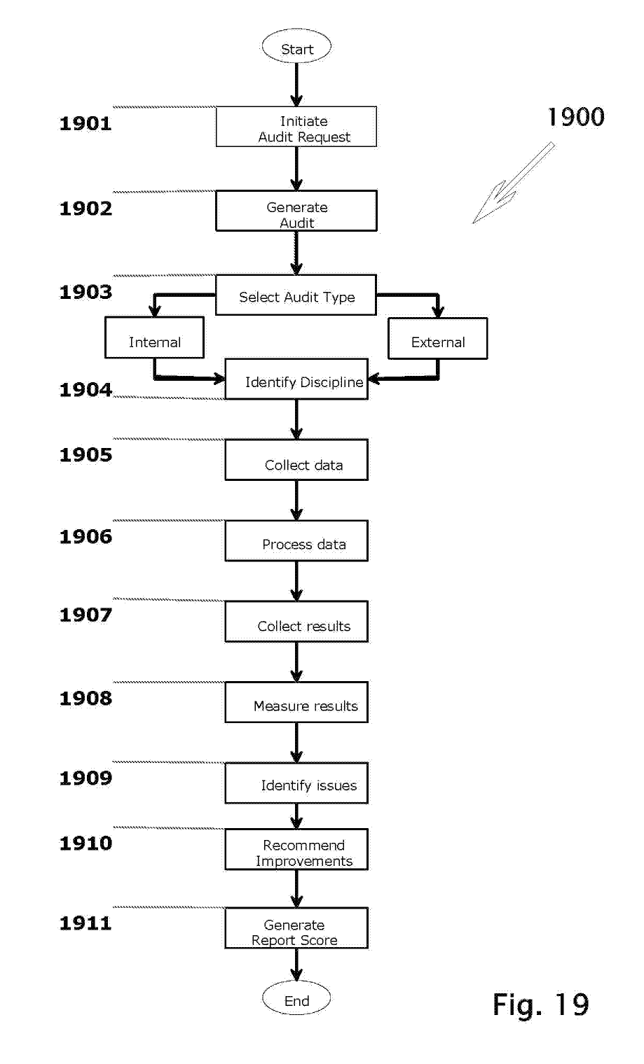

FIG. 19 is a flow diagram 1900 illustrates the automated auditing process of the project, in which an auditor can pull the necessary documents, collect data and measure results. It also, illustrates a feature of identifying issues and recommending corrective or improvements. The automated auditing process of the project, in which an auditor can pull the necessary documents, collect data and measure results. It also, illustrates a feature of identifying issues and recommending corrective and/or improvement actions. All as stated in FIG. 19 and as shown in 1901, 1902, 1903, 1904, 1905, 1906, 1907, 1908, 1909, 1910 and 1911.

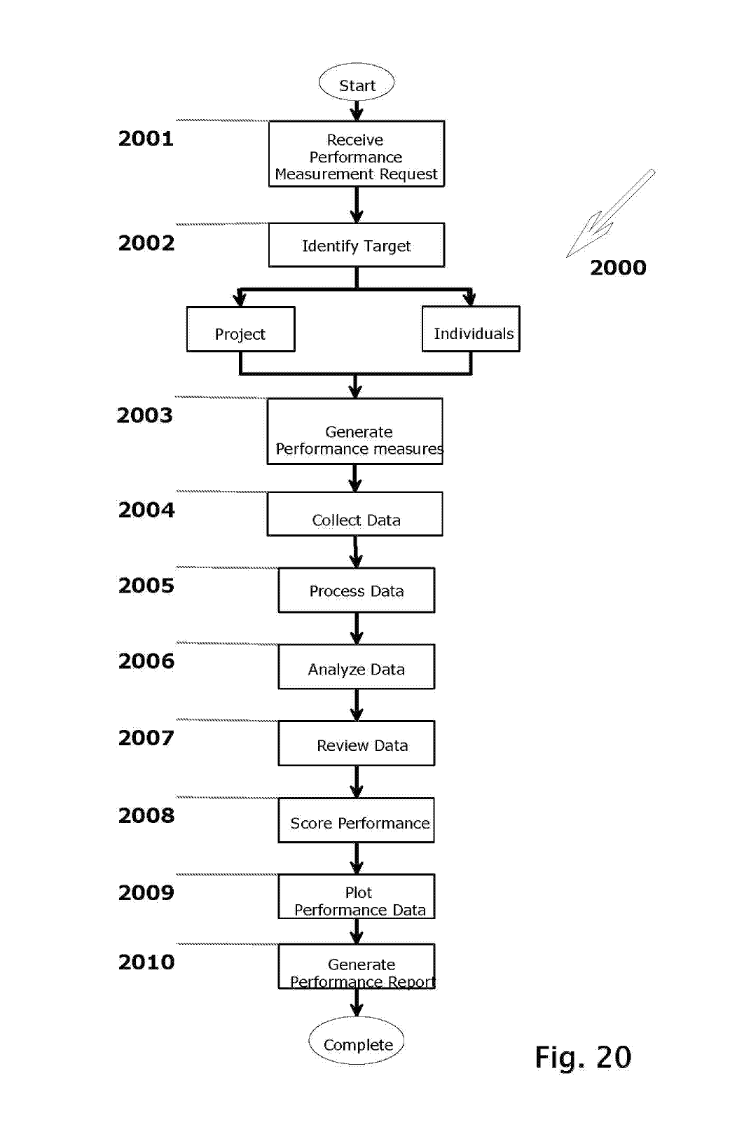

FIG. 20 is a flow diagram 2000 represents the performance measurements based on the preset performance indicators for both the project and the individuals working on the project. FIG. 20, is a flow diagram 2000 represents the performance measurements based on the preset performance indicators for both the project and the individuals working on the project. All as stated in FIG. 20 and as shown in 2001, 2002, 2003, 2004, 2005, 2006, 2007, 2008, 2009 and 2010.

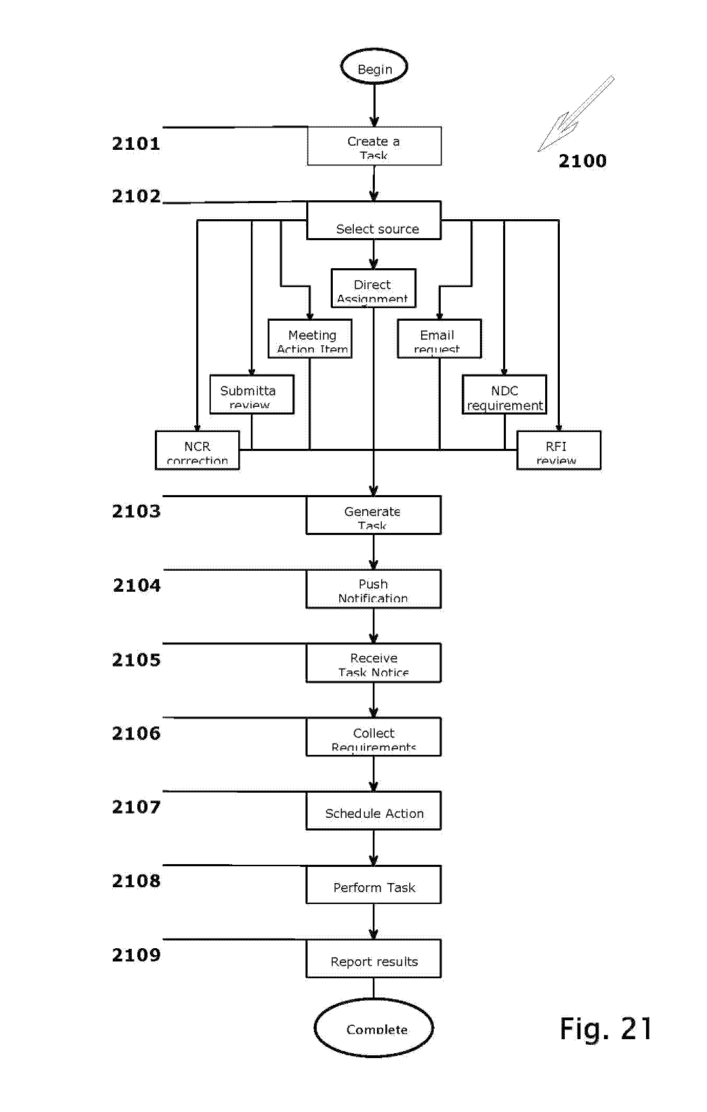

FIG. 21 is a flow diagram 2100 represents task management, it illustrates how managers can assign tasks to users and from different approaches, as a result of meeting action items, email assignment, direct assignment or other and at the same time it reflects how user will be digitally notified with these assignments and act on each one of them in a timely manner. The result of these tasks is documented and communicated with the issuer on a real time basis. The task management, illustrates how managers can assign tasks to users and from different approaches, as a result of meeting action items, email assignment, direct assignment or other and at the same time it reflects how user will be digitally notified with these assignments and act on each one of them in a timely manner. The result of these tasks is documented and communicated with the issuer on a real time basis. All as stated in FIG. 21 and as shown in 2101, 2102, 2103, 2104, 2105, 2106, 2107, 2108 and 2109.

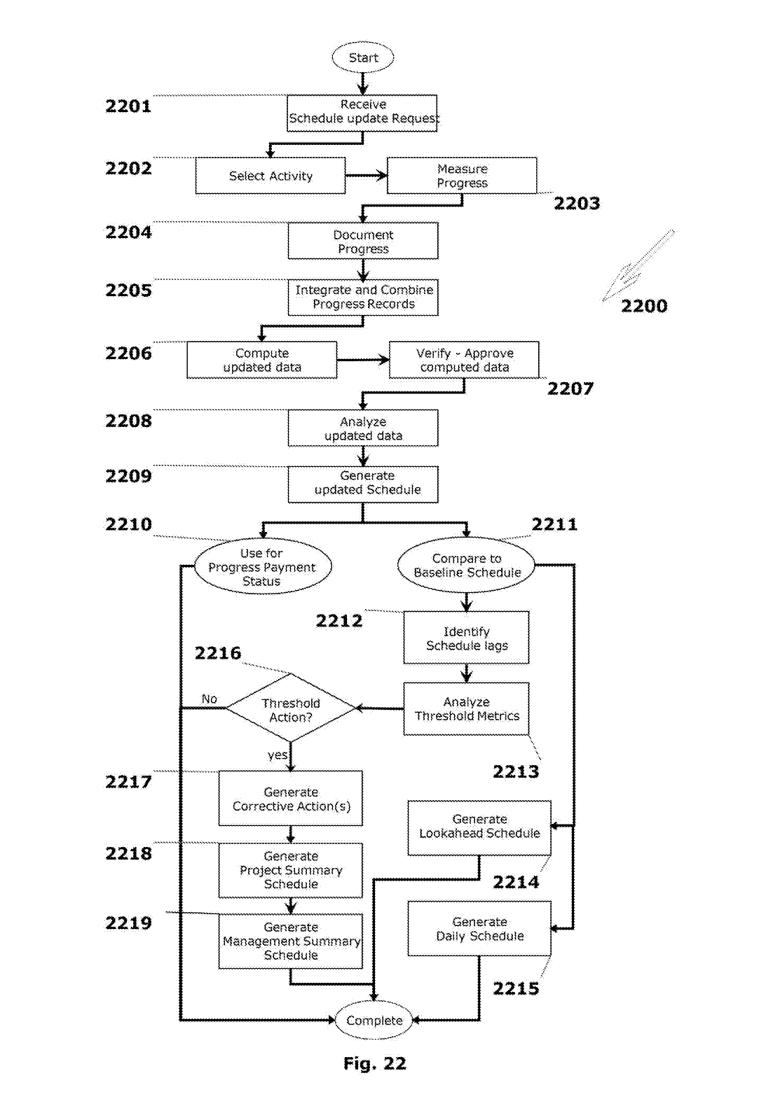

FIG. 22 is a flow diagram 2200 represents schedule monitoring process and provides actual schedule progress and updates at any point in time during execution, construction. Look ahead schedules and daily work schedule can be generated with more accurate data. Measuring actual project's progress and performance based on the earned values, activities duration and/or commodity helps management to better evaluate the status of the intermediate and completion milestones of the project to take an action while approaching project's thresholds. This method provides the tool to document actual work completed, update the remaining work schedule to reflect current work plans and regularly provide the data necessary to measure progress. All as stated in FIG. 22 and as shown in 2201-2219.

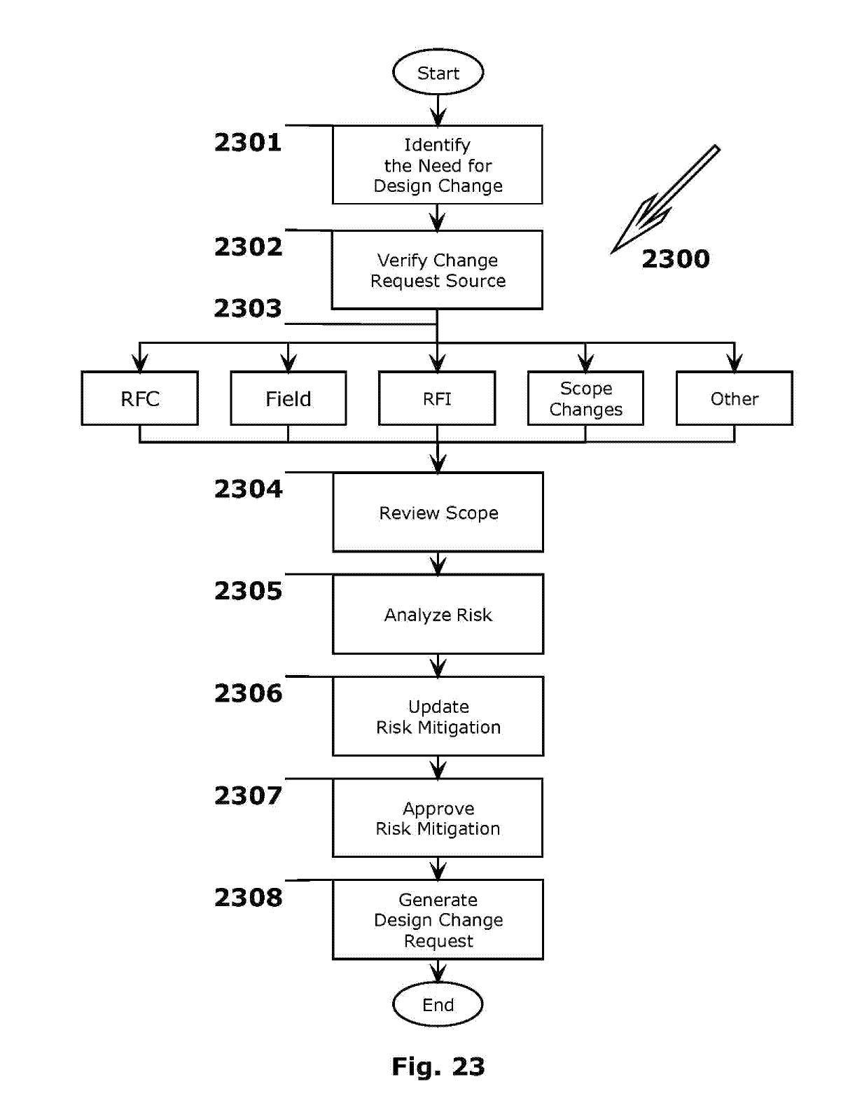

FIG. 23 is a flow diagram 2300 illustrates the Notice of Design Change (NDC)—of the project, such change may be initiated due to field conditions, a Request for Information (RFI) disposition, scope change, additional scope, an in-complete or unclear project plans or due to any other reason. This figure with the processes from 2301 through 2308 identifies the automated actions to be taken to initiate the design change request. Such process keeps all field's and other project's individuals aware of the construction status of any element on the project which eliminates any confusion related to project plans and prevents continuation on an error. Ultimately, the new design will be incorporated in the system ready for execution.—construction. This feature prevents errors and eliminates disputes and un-necessary removal; which saves the project cost and time. All as stated in FIG. 23 and as shown in 2301-2208.

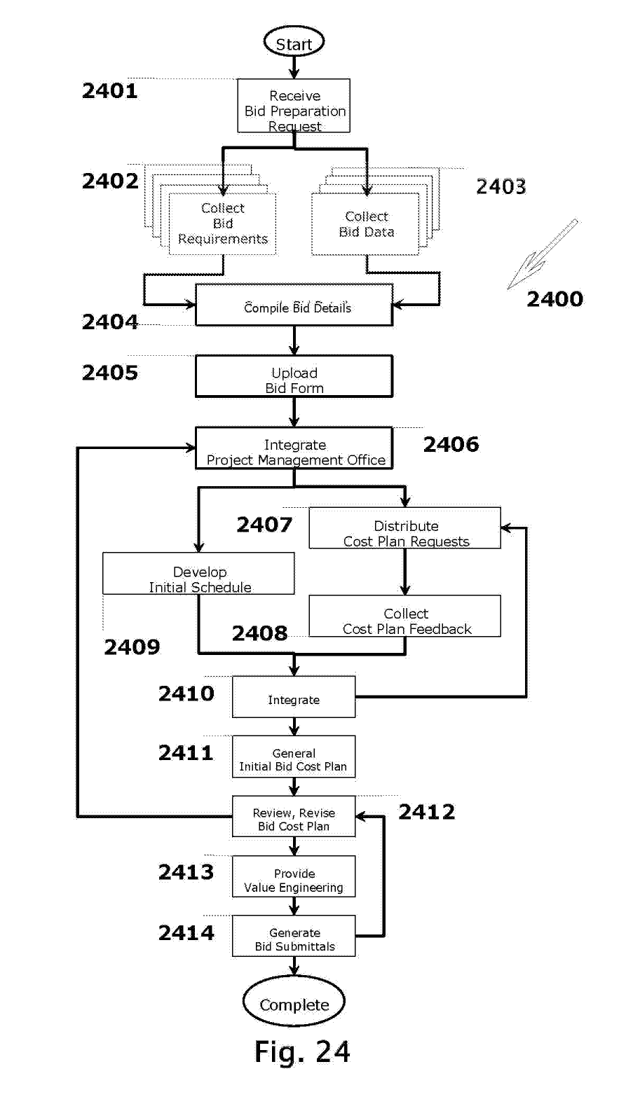

FIG. 24 is a flow diagram 2400 presents the automated bidding process and procedures, this incorporated feature in the system allows users at the member level to generate bid submittals including all required bid preparations that is not limited to take off and developing of the initial preliminary schedule of the project. Integrated cost loaded activities allow members to bid for the projects more accurately and prevents potential errors. This feature allows member's users to material, resources, equipment and time for all scope items and identifies all other work that is not in the scope at an early stage. Quality control and quality assurance costs and time are part of this feature, in which member can budget adequate cost for this work and allocate reasonable time too. This feature carrier bidding from initiation to closeout and acceptance, all depends on how detailed and accurate the project schedule may be. Project's Management Office database plays a major rule in this feature and allow members to benefit from the pre-loaded activity unit cost database. Such feature as illustrated in FIG. 24 process from 2401 through 2414 allow for unit costs as well as time and material activities; in which can be used not only during bidding time but for the work changes while executing the project.

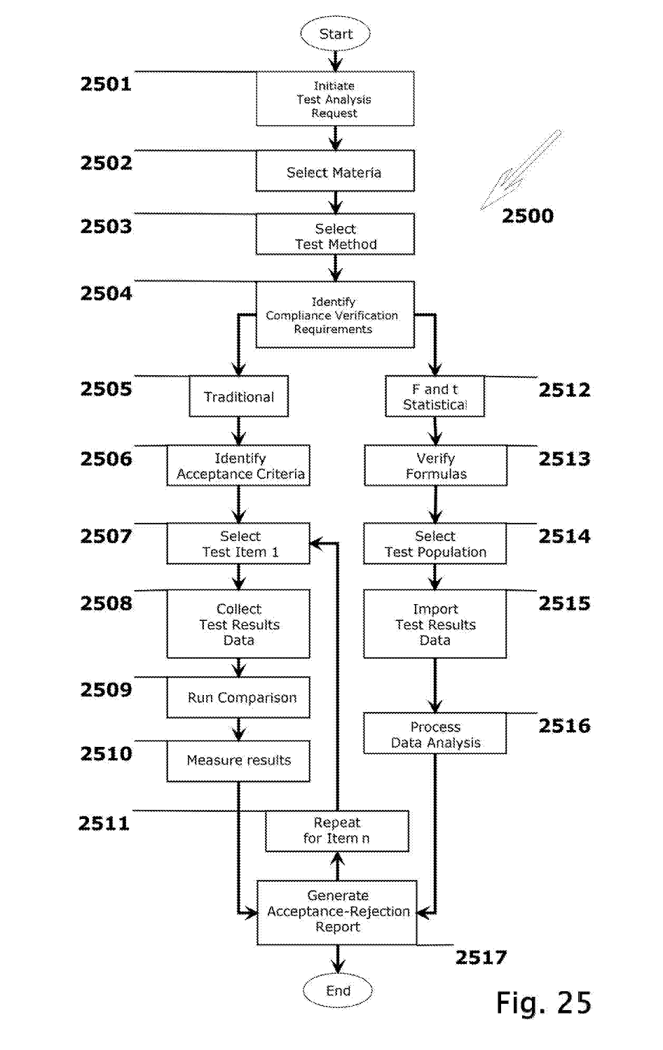

FIG. 25 is a flow diagram 2500 provides the materials tests compliance and verifications for quality acceptance. The system provides two methods for material testing acceptance, the Traditional which based on tolerances and the Statistical F and t analysis based on the standard deviation variances. User can select either method and can compare acceptance criteria by running same test results utilizing both methods. User's test results may be generated and input from the field or from any or all approved project's laboratories in which QC, QA and third party verifier's data can be compared and utilized for acceptance criteria. Such process as stated in FIG. 25, process steps from 2501 through 2517.

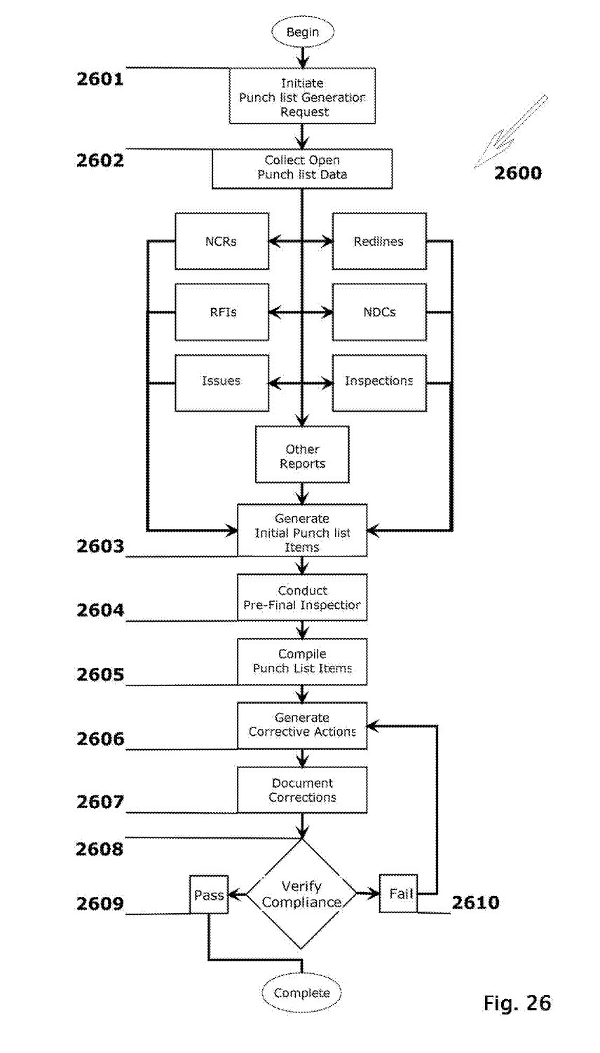

FIG. 26 is a flow diagram 2600 representing punch list items of the project, process steps from 2601 through 2610 are self-explanatory and state the capability of this disclosed invention to generate and provide punch list items at any time of the project. Such capability allows for real time corrections without impacting the level of quality and/or the project schedule. In addition, this capability and feature allows to achieve the highest possible quality levels and prevents potential delays, claims and/or rejection of any item of the project. All the potential open punch list items from the project during execution are the miscellaneous and minor items; the pre-final and the final inspection reports punch list items will be added to the initial punch list items for corrections. This process is repeatable until all punch list items are corrected and/or disposed.

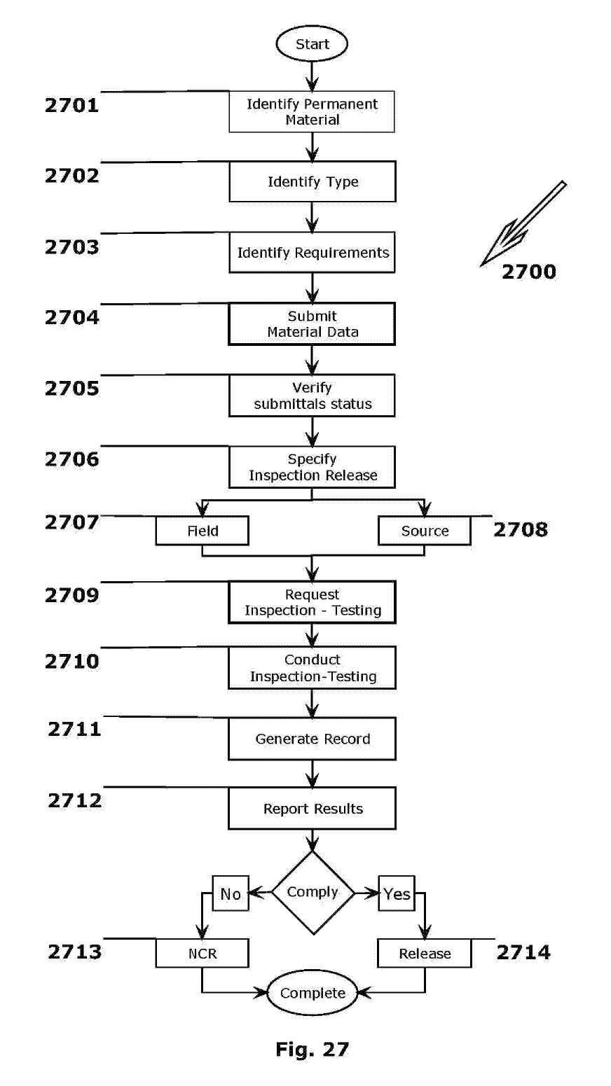

FIG. 27 is a flow diagram 2700 clarifies material testing process and procedure in this disclosed invention method. These material tests can be generated at the field and/or at the sources for thorough technical and quality verification on a real time manner. Such feature in the disclosed invention allows the vendors, the quality testers and verifiers to communicate and to conduct such work in a fully automated and shared environment. This capability allows the project management to monitor and track permanent material status on time and to prevent potential disputes and/or delays. Such real time data process enhances the need to generate material acceptance-rejection reports on timely manner which allows for faster release of passing materials. The automated process steps are as illustrated from 2701 through 2714.

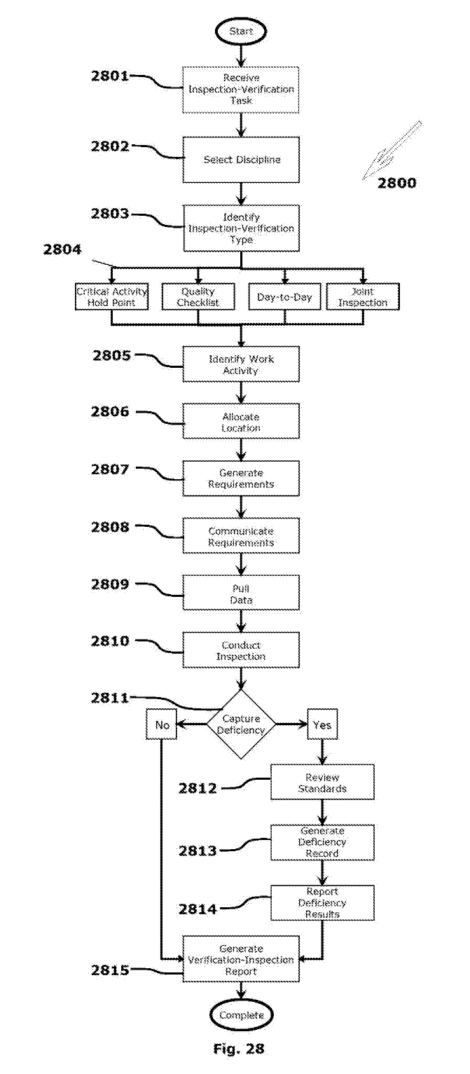

FIG. 28 is flow diagram 2800 illustrates the automated inspection and verification process provided in this invention. Critical Activity point of Inspection—Hold Point, Typical Quality Check lists, Joint inspections or day-to-day quality control, quality assurance and/or quality verifiers on the project. By means of this invention method and features, inspection reports can be automatically conducted at the field or at the source. Based on the work breakdown structure of the design—execution packages of the project, inspectors develop reports by capturing the lowest activity level available in the schedule which allow for though and accurate documentation and retrieval of specific data on a real time at any time of the project. After approval, office users can access, review, analyze and report on any of these reports or their contents. Such capability provides actual; project's timeline for the management and answers all questions may be generated by quality, construction, control, contracts or any of the project management team. This process methods are illustrated as stated in 2801 through 2815.

The General Composition and Functionality of this Program is as follows:

Members are the organizations who subscribe, download and utilize this program even if there is no project to manage. The General Administrator of this program can utilize it for Day-To-Day work and can initially setup projects and prepare Bids among other operations as mentioned above. Such setup is to choose the RULE of the member on this new project (Owner, Builder, Quality Manager, Project and/or Construction Manager or Both, Designer, or Oversight. In addition, the initial setup the Member has to choose the procurement category (type) of this new project, is it, Design-Bid-Build (DBB), Design-Build (DB), Design-Build-Operate (DBO), Public-Private-Partnership (P3) or Construction-Manager-General-Contractor (CMGC), sometimes defines as Construction-Manager-At-Risk. Once Specified, the system will automatically gather and collect all related data, forms and procedures for these choices. For each procurement module and rule type there are specific requirements, process and procedure; forms, templates and management system varies too. Responsibilities and Risk on each one of them is not alike. General administrator's interface can be accessed from office and field thought PCs, Tablets and Cell Phones. The member can setup new projects as it requires, i.e. can be a Builder on a DBB project or on a DB project and/or on a P3 project; same for other groups (Members) or under any other combination.

Project Administrator is the project specific individual who communicates with the Organization (the Member) and the Project Management Office and Project's Databases. At the same time, continue the project setup after award. Updating, adding, editing forms and other project's needs are part of the PA tasks including project users contacts and devices. Project Administrator's interface can be accessed from office and field through PC, Tablet or cell phones. Being on the project, this user (PA) can access the quick and emergency response interface too. After award, Member's Project Administrator can assign other groups (organizations) to be users on the project under their own categories; such cam be Quality, PCM, designers, oversight or others. Such capability integrates the project teams under one project team of different rules.

Project Users are classified as Office Users and Field Users;

Office users utilize office based interface that is accessible from PCs, Tablets or Cell Phones, specifically designed and developed mainly for project management team such as Project manager, Contracts, Controls, Design, Safety, Quality, Environmental, Specialty and Construction), all can access the quick and emergency response interface too.

Field users utilize their Tablet specific interface, and can be accessed from PCs, and Cell Phones too. It was designed and developed specifically for Field users; inspection reports cannot be generated from the office, but from the field and can be edited and completed at the office but from the tablet not from the PC. These users can access the quick and emergency response interface too.

The preferred embodiments of these systems and methods will be illustrated in this invention by utilizing the construction project management as an exemplary module. Such an industry has been chosen due to its complexity while this invention provides complete solutions to conduct typical program or project management tasks from initiation to closeout.

Although, the management of construction projects is very dynamic and classified as the most diversified and complex industry to manage, especially when it comes to mega infra structure projects this program allows for real time data update and sharing among all stakeholders; such depends on and based on the pre-authorized access privilege to each user. This disclosed invention resolves the problem of construction diversification and complexity and decreases the risk based on the procurement and delivery systems of these projects.

Due to its customizability this computer program, is applicable to all types of industries, in full or in partial and the upcoming details are oriented to focus on the construction industry as targeted example for this applications.

This program allows for all or any of the stakeholders to utilize their part of the solutions and to integrate all permitted data through a standardized shared platform while keeping other data as an internal use only. These platforms compromise different interfaces to allow each applicant/user through any terminal to perform plurality of required duties and tasks with highest possible productivity and lowest errors, all data are automatically saved and transmitted for further correspondences or actions on a timely manner. These solutions allow for office and remote/mobile users to automatically communicate, share and integrate data, reports and all other project documents on a timely manner while all information are automatically saved on the server's at project's database.

The general setup of this disclosed computer program solutions is to be utilized by any organization to manage their programs or projects as Owners, Designers, Builders, Quality managers, Consultants, or Oversight; all functionalities are under any type of project delivery or procurement module, design-bid-build, design-build, public-private-partnership, construction manager general contractor, or design-build operate projects. The solutions provided standardized project management processes for each member under either one of the delivery modules. In addition, the disclosed invention allows for program customizability to allow for program utilization for any other engineering or non-engineering industry.

This program enhances project planning, ties executing with monitoring and controlling and leading project towards completion and closeout through a very specific and automated performance and progress measurement and monitoring solutions. The unified document control and filing solution is another major part of this program that eliminates complexity and enhances compliances. Specific dashboard for each interface type were designed to ease and simplify utilization of this program and at the same time to prevent interference and miscommunication between departments and stakeholders.

All project users can access their specific interfaces through different computer devices, terminals like desktops, laptops, tablet and/or cellphones. This advantage allows users to stay in touch with their tasks and with the project in general at all times to maintain productivity and to increase performance to assure successful project completion.

Construction, Quality and Risk management solutions are major composites of this program; due to the functional and requirements similarities between Risk management ISO 31000 and Quality Management ISO 9001 especially when it comes to uncertainty, this program partly integrated the two process groups into one solution. Quality and risk management integration provide adequate tools to eliminate confusion and to better mitigate risk and provides clear, common understanding and uniform knowledge on project's quality. In addition to the Communication, Quality and Risk management solutions, the disclosed program address other program/project management process like Integration, Scope, Time, and Cost management groups. Human Resources and procurement management groups are managed at a sectorial section especially dedicated for each stakeholder/organization based on their specific rule and operation.

As stated in several section of this disclosed invention the method and procedures of this program are tentatively presented in the enclosed illustrations and figures, it is appreciated to be understood as follows:

The disclosed invention is an automated computer program method and system directed to the project management profession in three parts-tiers and provide an interactive and responsive platform utilizing web application and methodologies. This invention is beneficial for owners, builders, designers, quality management organizations or teams, consultants, and/or oversight and their sub-contractors, vendors and suppliers. These solutions are applicable under several contract and procurement types, design-bid-build—DBB, design-build—DB, public-private partnership—P3 or construction manager general contractor—CMGC to perform their typical day-to-day operations including project specific management needs. The presented solutions carry specific characteristics that is not limited to flexible, adaptability, adjustability and customizability to ease utilization and automate processes and procedures.

These solutions benefit and improves the management profession and optimizes the project management performances while functioning on-line and off-line with a need for synchronization to replicate data between the user's terminal and the mainframe server, such synchronization allows same data and information to be copied on all other terminals within the project's network. In addition to the automated bidding features, this invention includes modules and packages for project management and management areas include safety management, environmental management, design management, contracts and procurement management, project control management, construction management, quality management and specialty management such as the right of way acquisition, intelligent transportations systems, tolling or any other supporting project that is not in the main scope of the project. Also, the post construction within the warrantee period, commissioning, operation and maintenance as an example.

Through the general features and the project management office features, the presented invention provides templates for project management plans, forms and checklists including tracking and control logs ready to utilize and conduct work from initiation to closeout. This disclosed invention has other standalone packages incorporated and engaged to provide complete project management solutions. In addition to the mentioned capabilities to perform day-to-day operations, these complete and automated program/project management solutions have the capability to function during the phases of pre-work/execution/construction, during execution/construction and post completion of the project, these capabilities can be implemented from an office work environment or remotely under field work environment.

Specifics and details of the preferred embodiment:

The disclosed invention is a cloud based optimized method and system in a computer program product directed to management solutions for the management profession that standardized the process and procedures and facilitated implementation from project initiation to project closeout.

This computer program product implemented method executing an online computer system compromises two computing parts, a cloud and computer devices classified in this invention as terminals, the cloud is connected to virtual server and a mainframe server in which the master and sub-databases are built as part of this computer program and the terminals are any of the typical computer devices like office PC, laptop pc, tablet pc, and smart cell phone. The computer program system carried over this invention in five user's interfaces.

The cloud, server, database part/tier is the carrier of the program solutions and provide the master database for the member, this database is compromising three major sections, the day-to-day management work, program/project management office database and projects databases, regardless of their type and number and regardless of the member's rule on these projects. The cloud database is loaded with a website templates for the new member to pick from and build project specific website. Same is used to develop project specific emails for all project users.

This computer program implemented a method and system for member's (organization) utilized to be utilized through several interfaces, the general administrator's interface, the project administrator interface, and the project users interfaces; under an office and/or remote (field) work environments. Such capabilities compromise the interface for the general project management, the safety, environmental and SWPPP, design, contracts, control, construction and quality management areas, an extra management area for specialty work like right of way acquisition, intelligent transportations systems, tolling or any other supporting project that is not in the main scope of the prime project's contract. The project user interfaces compromising of two interfaces, one for the office work environment and the other is for the remote and field work environment. The fifth interface is set for all member's personnel as long as they are on the same project, this is the smart cell phone interface and it is the quick crises and incident responding interface; in addition, it provides capabilities and features to manage post construction within the warrantee period, commissioning, operations and maintenance. All or any of these terminals can synchronize with the cloud server in presence of internet, intranet, or Wi-Fi connection, otherwise terminals can function off-line and the devices can carry all new generated data until synchronizing and exchanging back-and-forth data with the server's database.

This computer program implemented a method and system for, general administrator interface components and elements for day-to-day management, operations, program and project management office components and pre-work/construction module and components that include all required work processes and procedure from project preparation/initiation until contract award.

This computer program implemented method and system for, project administrator interface components and elements for the day-to-day operations, communicating with the program/project management office, setting-up a new project or continue setup an existing project. Project setup includes but not limited to assigning new individuals classified as users of this program on a specific project, building, updating and maintain the project's website contents, creating project individuals' emails, and more.

This computer program implemented a method and system for, users remote/field environment interface for all supporting services and work from outside the office work environment, such embodiment work is not limited to technical and non-technical inspections, material testing and releases, issuing RFIs and drafting NCRs and more. All project users through their cellphones can utilize a quick crises and incidents response interface for the major work elements meant for and to enhance efficiency and productivity by having shared modules for traffic planning, requesting, implementing and reporting, meetings management is included in this module in addition to the shared modules in capturing technical and non-technical deficiencies and enhances safety of the remote workers at work zones by initiating their reports and responding to their assigned work tasks and to-do-lists.

Although, user Interfaces depends on user's position, responsibility, function and physical location within the project, but all user's interfaces share and contribute to the project completion and closeout requirements, in addition can be shared and utilized to carry any post construction work and assignments. The complete disclosed invention with its three parts/tiers and the five interfaces carries features and elements to facilitate utilization and implementation of the complete optimized project management modules.

In this disclosed invention all project interfaces are loaded with project specific email and messaging features, in addition to that all mobile interfaces are loaded with camera that is integrated with the program uploads photos to the specific report it was opened from. Each one of the mentioned applications/interfaces has its own features that may be shared with other interfaces or to be pre-set for a specific interface.

The following detailed specifics describe relations and provide more highlights on project specifics interfaces and functions.

Cloud-Server, Database and Terminals: The cloud based server through an on-line web-based platform composes the server part/tier of the program in conjunction with the other computer devices on the same project. The server hosts the mainframe database for each member/organization to allow project's computer devices/terminals to communicate, add, extract, edit or update. These Terminals are either office based or remote, all devices are considered and labeled as the terminals of this program. Each part/tier of this program databased server and the terminals may operate independently. Synchronization feature requires internet connection and allows for exchanging data between both parts/tiers of the program and ultimately shared with all program users.

Terminal users are not required to save data while working on their devices, the program saves all data automatically and exchange it with the server's database while synchronizing, then data become visible and accessible to other project's users as read only documents. No user can edit and modify any project document except the generator or the assigned reviewer, approver and/or the manager of that individual. By this advantage, terminal user can function without any access to internet (off-line) and then synchronizes used device (terminal) on a regular basis to assure consistent data exchange and frequent updates of the project documents, records and data. On complex projects, internet access is recommended to all users at all times, and several synchronizations during single shift hours is preferable.

Through the cloud server office, remote users can access the program and conduct their typical day to day activities. This system functions by means of typical computer devices like desktops, tablets and mobile cell phones, from office base computers or remotely, all through a cloud server. In addition, based on the member's need and through the cloud server, this program can integrate with other published computer programs and software (third party programs), utilize their features and implement in this disclosed invention.

In these solutions, user interfaces are pre-defined and classified into five different interfaces; four interfaces are accessible and functional through any type of computer devices or a mobile cell phone and not directed toward a specific computation system, all available computer systems are capable of accepting this program and facilitate the described functionalities of this invention, all are inter-connected to the central cloud server database, the following information provide more specifics for each interface and its functionality.

General administrator Interface: This interface provides features to the member's general administrator and delegates to perform all pre-bid, pre-construction work. In which, typical day-to-day activities can be performed utilizing this disclosed invention and accessing other office and computer program, all documents, information and data can be saved and utilized in member's future programs or projects in simple and systemized steps. In other words, if the member does not have any ready program or project to manage, still can utilize this program to communicate, market, advertise, apply and/or prepare for new programs or projects. Such features provide member's general administrator's interface users the capability to manage meetings, tasks, action items and other daily office work. As stated, the quick access, short cut and links features allow general administrator's users to access third party programs and utilize them for their day-to-day activities and in preparations for the new programs or projects. The war-room is the access to start a new project under a pre-bid or pre-construction, inclusive feature facilitate the project preparation need which starts with project preparation and ends with project awarding process.

Standard management form templates are added to this interface with an option for the users to modify, adjust, edit or create new or specific forms based on their needs. Such editing or creation does not influence or affect the standardized project management process and procedure of this disclosed invention. Such facilities can be migrated or uploaded to the new programs or projects while utilizing the adding new, setup or projects features. This program provided several access points for each feature to minimize search and to allow users for faster and more productive work environment. Through same interface, users can edit users profiles and update member's and user's information, upgrade the program and call for customer's support, all are under one interface.

Member's general administrator's interface users can move away from the member's organizational platform and interface and access each project at a time. Such back and forth access function allows and provides the management with a real time opportunity to monitor all active projects and several levels of reporting without waiting for outdated or delayed project's feedback. In such case, member's general administrator can not only monitor and access projects details, but at the same time can import and integrate organizational important data related to financial and time performances. Project's specific executive reports are integrated in one organizational performance reports.

The General Administrator's interface serves as program/project office center, in which the general administrator can handle all pre-contract award, pre-construction work and can delegates some of or all of the features to a deputy general administrator and to other general administrator assistances. Either user of the general administrator's interface can set up a new project and/or assign a specific project's administrator while maintaining accessibility and functionality through the project's specific interface; such capabilities provide the member with full program/project management office features.

Project administrator Interface: In other words, this is the project specific interface designed for the project administrator use only. The project administrator is not necessary to be the project manager, but can be any individual who can handle the project's setup and update. At the same time, this interface can be used as a back and forth communication tool between the project and the member's general administrator, which is the program/project office support. Such feature maintains the ties between the organization and the project, and at the time prevents any disconnect and disengagement between both. In addition, such feature, prevents any surprises or unforeseen impacts on the organizational finance and/or potential legal implications. On the other side, such feature provides real time data and improved work environment for the organization's management to take the right business decisions at the right time.

This interface cannot be used as a supplemental access to project's details and records but provides access to project logs and executive reports that reflect the actual performance of the project. The add new, setup and profiles features provide project administrator the tools to setup the project specifics and requirements and to add new forms or to modify existing templates or logs. Project administrator through project's specific interface can setup, edit and or update project data and project users and their classifications including their roles and responsibilities.

In addition, project administrator through this interface can add or update user's classifications, information and/or their access privileges. This project administrator's interface can access all reports, project documents and records for the purpose of download or save on a conventional desktop or external hard drive. This interface like all other interfaces of this disclosed invention can share project data, files, documents or records through project's specific email or message services, and such process is automatically documented as a project action.

This interface is loaded with the typical feature on other interfaces, to seek technical support and to upgrade the software either automatically or manually. In addition, this interface is loaded with Meeting management package, action items and to-do management and can be used internally or throughout a thirst party to conduct several levels of audits on the project.

Project administrator shares with the general administrator the projects setup features based on their contractual delivery module Design-Bid-Build (DBB), Design-Build (DB), Construction Manager General Contractor (CMGC), Design-Build-Operate (DBO) or Public Private Partnership (P3) project. At the same time, the project administrator can define and setup the functionality of all stakeholders, designer, builder, owner, quality management, oversight, project and construction management or any other function the stakeholder may provide. Part of the project setup, the project administrator can interrupt the standard forms this program provides and edit, modify, and/or create new forms and logs based on the project's need, specialty and specifics. This interface cannot be used as a supplemental interface for project's office users interface number 3.

Project specific office users Interface: In other words, this is the project specific interface for all office users, field, remote users can access their designated work interface number 4 through desktops but not this specific interface. Office users are project manager, leads, managers and other project staff and assistances. All can access their designated areas for this disclosed invention program to function accordingly. The standardized project management areas/groups in this disclosed invention are the upper project, design, safety, environmental, construction, contracts, quality, controls and the extra specialty management like right of way acquisition, intelligent transportation systems, tolling for express lanes or any other specialty project supporting not in the scope of the main project. In addition, it handles the post construction within the warrantee period, commissioning, operations and maintenance.

All office users and based on their designation can access, edit, add, modify or create new project documents and records, project logs. Each management area was designed in this disclosed invention to address the standardized process groups and their related requirements from initiation to closeout. Project setup at stated in interfaces number 1 and 2 and as detailed in the details below customize required and needed process for each group and the system provide the necessary forms and logs needed for this specific type of work and during the lifetime of the project. In addition, as stated in interface number 2, the project administrator can modify, edit, adjust and/or create new forms and logs to suit each project on as needed basis.

This office user's interface is loaded with a master dashboard feature, this feature allows for monitoring the project status on a real time and reflects project, specific and/or individual's performance measurement, all based on the specific user's search criteria. In addition, this disclosed invention is loaded with a self-auditing program that highlights success and failing areas. Such can enhance and alert the project management to the weak areas and to perform needed improvement on the project, all to assure successful completion.

As in stated and detailed all other user's interfaces the features of action items, to-do-list management, tasks and assignments are loaded on this interface to facilitate and ease workmanship performance on the project, same apply on meeting management feature.

Project specific remote users Interface: In other words, this is the project specific interface for all field and remote users regardless of the work discipline assigned to them. Pre-loaded features to this remote interface facilitate field and source inspections, communicating and reporting on a real time with project management. From which, field engineers, inspectors, material engineers and inspectors, samplers and testers can conduct their typical field's work or source work without the need to return to the offices or the need for other means to seek project information. All project's data and references are available through this interface and accessible to all remote and field workers. All can access and use the latest approved construction project plans and their approved updates for construction inspection and verifications; same can be used to redline the plan sheets to document the initial as-built drawings for the project. Construction submittals and approved Construction shop drawings can be accessed and utilized and used to assure compliance.

In addition, field users can access all field's reports and other construction related project documents including project schedule updates and the look-ahead work schedule. The daily work schedule and the daily approved lane closures plans shall be available for all field's users to utilize function accordingly. Field workers can general and draft and track requests for information, technical deficiencies and reports and at the same time can draft and track non-conformance reports. Remote project's dashboard access is limited for the field users to monitor construction related items and field's work performance. While project schedule feature is available for all field team to monitor and track construction status and progress and to report any non-realistic schedule status item. Traffic Management and Traffic control management is another feature field user can benefit from, and more details will be explained in user's interface number 5.

Field workers can utilize the email and messaging service while away from the office. Field's team can conduct field meetings and/or attend office meetings while keeping all data and information up-to-date. Assignments, action items and to-do tasks are automatically managed and managers can be informed with status and progress on-time. All minor and non-corrected deficiencies are to be documented and accessed through the punch list feature and field team can add new punch list item while conducting their typical day-to-day work. At any time of the project, all project documents and records are automatically saved and integrates with the project's specific database, the close out feature and the closeout tracking log reflect the project closeout status and both office and field teams can monitor closeout progress and work towards completing missing documents or records.

Photo management feature, allows for capturing project's photo documents and incorporate these photos at the report where they belong too, user can mark, and write on the photos, while the system automatically assign, name, date, time, location and 3-dimensional GIS coordinates for each photo; pre-defined photo naming convention will be automatically inserted and tag each photo. All projects photos are also saved at a project's master photo file to track project and construction progress time line. These photos can be taken, labeled, saved and documented as either one of these categories Pre-Construction, During construction and post construction.

This disclosed invention facilitates automated features to fill up name, day, date, time and weather tracking status in each generated report without any interference from the report creator. Report creator can edit and adjust some of this information based on the situation the report is generated for. At the same time, remote and field users can access the weather forecast to document and alert project team of any upcoming weather situations. All project reports, material, inspection, sampling and or testing automatically carry project document serial number and report creator can assign an extra report number specific for the type of assignment and the creator. In addition, field, remote users can access their specific interface number 4 from office desktops to edit, complete and sign their pre-generated reports prior to submittal for review and approval.

As will be stated and detailed in the quick users interface number 5, field's users can utilize this remote interface number 4 to respond on the emergencies and incidents including automated sequential crises management communication and reporting. New inspection reports feature allow field's users to pick their assigned inspection reporting template or pick another pre-designed format for any newly assigned work or any extra work type they may have tasked with. Hold point or Critical activity point of inspection reporting is a joint report more than one user for several organizations can share and documents their findings accordingly.

Project specific quick crises and emergency response Interface: This extra interface was specifically designed to enhance the functionality of this disclosed invention by means of a mobile cell phone utilization, it is the quick response and emergency interface. The embodiments of this interface carries features specifically designed for the mobile cell phones and accessible to all users while on the project level of the application. In other words, this the quick crises and emergency management interface is directed for all project assigned users.

While in the field, any of the project users can respond to crises, emergencies, incidents, this disclosed invention provide systematic process for to utilize and implement, starting from calling emergency responders phone call ending with documenting and reporting the incident. Communicating with project safety team and managers through solutions phone calls, messaging and/or emails features are part of this solution, in which and under tremendous stressful situation a user can perform such crises management through a pre-standardized process to call project's and formal emergency and safety responders to the scene in timely manner. Similar feature was specifically designed for near misses' documentation and reporting.

In addition, this interface provides adequate features for construction production team to pre-plan their construction needs such as required traffic closures at the work zones, for the traffic managers to review, approve and request such a closure and to assure agencies approvals in advance. Such, will allow traffic controllers to implement the approved closures and for traffic monitors, directors and inspectors to assure compliance and to conduct thorough traffic control and closures reporting. Management can access these reports and monitor traffic control and closure implementation performance.

In addition, this quick interface carries extra features were designed and incorporated for meeting management, task orders and to-do list or action items. Project users, can use the portable cell phone in lieu of a tablet to conduct meetings management tasks. It is an innovative feature that is added to the quick and responsive interface number 5 to schedule, invite, conduct, document project's meetings. Any project users can facilitate this feature to their specific use and all meeting attendance, minutes and action items are automatically documented in the project's records. Action items and/or tasks resulted from any of these meetings are documented and action items are automatically communicated with tasked individuals to follow up and complete. In addition to the crises and incident response functionalities and to facilitate better performance and to provide safer field's work environment, users may use this terminal (the cell phone) as a start for an inspection reports, photo document work environment and details, capture deficiencies, conduct, attend and contribute to project's meetings, plan and track closures and traffic control items without the need to carry bigger and may be an un-safe computer devices (tablet) while working within construction zone environment.

One click, from this quick interface returns user to the designated interface usually functions from. In specifics, Field users shall return to their field, remote users interface number 4, office users will return to project's specific user's interface number 3, and project's administrator along with general administrator shall return to project's administrator interface number 2. In this case, the smart portable cell phone can be used as a functional portable device to conduct and to respond on typical project's work regardless of the geographical location of the user. Here under are more details of the preferred embodiments; the embodiments compromising:

Interface number 1: In an aspect, day-to-day operations, includes the capability to perform the following functions by member's general administrator and other office teams: Day-to-day operations, the ability to perform the following functions:
i. Meetings,
ii. Tasks
iii. Messages
iv. Business collaboration, transmittals and correspondences:
   1. Manage business processes;
   2. Customize business needs to preferred formats;
   3. Link member's organization to preferred leads;
   4. Manage mail-in mail-out;
   5. Customize routing of business processes;
   6. Track business collaborations and performance;
   7. Access organization's projects, monitor and track performance;
   8. Provide required back up for organization's projects;
   9. Track and record projects lessons learned;
The method, wherein said Day-to-day management work and activities comprises at least one of the management's day-to-day activities.

Interface number 2: In an aspect, Pre-Execution/Construction: includes the capability to perform the following functions by member's general administrator and other office teams.
A. Pre-Bid—Project Preparation:
   Project Initiation, Planning and Project Setup, Initial
Create, modify or update existing project management plans;
Collect project requirements;
Specify scope;
Initiate and develop project's preliminary schedule;
   Initiate work breakdown structure
   Specify project's activities
   Estimate resources
   Estimate durations
Estimate and allocate budget;
Identify member's quality rule on the project;
   Quality control
   Quality assurance
   Independent quality assurance
Risk management;
   Identify risk
   Conduct risk analysis, quantitative and qualitative
   Plan risk responses
Procurement management;
   Plan procurement
Communication management;
Integration management
The method, wherein said Pre-Execution/Construction Pre-Bid, Project Preparation work and activities comprises at least one of the management's activities of:
B. Bidding

Bidding and Bid Solicitation:
Link member's organization to preferred leads;
Develop and manage pre-bid qualifications;
Perform business marketing and promotional efforts;
Provide bidding solutions for several types of procurement systems

Uniform Filing System:
Link the uniform filing system (UFS) to member's organization;
Update the UFS categories;
Modify and adjust the UFS Categories;
Provides project specific UFS and ties data to organizational UFS Categories.

Document Management and Control:
Link the standard document management system to member's organization;
Update organization's document management system;
Modify and adjust the document management system;

Project Bidding:
Review bill of quantities;
Review statement of work;
Generate bid bonding requirements;
Complete and submit bid;

Contract Award:
Generate project bonding and insurances requirements;
Delegation;
Develop initial project submittals;

Collecting data

Project Preliminary Schedule

Inputting estimates

Completing and submitting bid
The method, wherein said Pre-Execution/Construction, Bidding work and activities comprises at least one of the management's activities.

Interface number 3: In an aspect, after award, during work/execution/construction, includes the capability to perform the following functions by project's administrator:

Update Project Setup:
Update user's information and access privileges:
Generate utilization reports and analysis:
Maintain and update the program/solutions:

Continue Project Setup, Project Setup, Continuation:
Project Forms and Templates
Project Process and Procedures

Project's Teams and Resources, Maintain and Update Project's Information
Assign users and their classifications and access privileges
Project Permits
Environmental Permits
General Construction Permits
Other Specific Permits
Project Initial Submittals
Project Schedule
Project management plans
General Project Management Plan
Safety management Plans
Environmental management Plans
Environmental Plan
SWPPP Plans and/or WPCP
Quality management plan
Construction management Plans
Traffic Management Plan (TMP)
Updated Traffic Handling Plans (THPs) and Motors Information Plans (MIs)
Communicate and seek support from member's project management office
The method, wherein said During Execution/Construction after award, Project Administrator's work and activities comprises at least one of the management's activities.

Interface number 4: In an aspect, during work/execution/construction, includes the capability to perform the following functions by project's management and inspection teams from an office work environment:

General project management: Conduct or facilitate Performance management measures; Tracking and Performance.
Project performance
Individual's performance
Monitor progress
Conduct or facilitate project audits;
Auditing
Conduct or facilitate project trainings;
Track project completion and closeout;

Safety Management:
Safety management
Health and Safety
Traffic Safety
Law Enforcement Services (COZEEP)

Environmental and SWPPP Management:
Permits compliance
Inspection and reporting;
Environmental Compliance reports
Develop SWPPP and or WPCP Plan
Implement the plan
Maintain BMPs
Amend and Update the Plan
Conduct field Inspections
Report Compliance/Deficiencies
Report performance

Contract and Procurement Management:
Change management;
Directive letters
Differing site conditions
Liquidated Damages
Labor compliance;
   Disputes and potential claims management; Complaints and disputes management
Sub-contracts
Change Management

Design Management:
Develop Released for construction plans and drawings—RFC;
Develop traffic handling plans and updates;
Develop Motorist Information Plans and Update;
Develop Construction Area Signs and update
Develop Notice of design change—NDC;
Develop Shop-drawings Released for construction—SRFC;
RFI
As-Build plans

Project Controls Management
Schedule update
Progress and payments
Quality management PDCE (Plan, Do, Check, Act) or PACE (Plan, Act, Check, Excel) or QE4S
F&t Analysis
Quality Performance analysis
Quality Reporting
QC;
QA;
IQA;
Quality improvement;
The method, wherein said During Execution/Construction, Project Management and Inspection Team work and activities from and Office Work Environment comprises at least one of the management's activities.

Interface number 5: In an aspect, during work/execution/construction, includes the capability to perform the following functions by project's management and inspection teams from a field work environment:

Field inspection and Office work: Most of these activities are back and forth between office and field.
Safety;
Environmental and Storm water pollution prevention plan—SWPPP;
   Develop SWPPP and or WPCP Plan
   Implement the plan
   Maintain BMPs
   Provide data to amend and Update the Plan
   Conduct field Inspections
   Report Compliance/Deficiencies
   Report performance data
   Services;
   Traffic and closures;
   Plan a closure
   Review and Request a closure
   Verify and Approve Closure
   Implement a closure
   Report Closure compliance and performance
   Construction;
   Request for information RFI
   Non-conforming issues and reports NCR
   Utilities, dry and wet;
   Source inspection:
   Source/Plant certifications;
   SRFC verification;
   Generate inspection report;
   Verify compliances and generate related reports;
   Conduct releases;
   Materials verification, testing and acceptance:
   Material receiving reports;
   Material placing reports;
   Material sampling reports;
   Material testing reports;
   Quality Control, Quality Assurance and Independent Quality assurance
   NCRs
   Punch list
   Material Engineering
   Inspection, Testing and Releases
   Field Releases
   Source Releases

Construction Management:
Construction planning;
Construction Submittals management;
Request for information; RFIs
Traffic Management
   Closure management
   Law Enforcement Services COZEEP management
Specialty management Specialty management, special disciplines and/or operations and maintenance:
The method, wherein said During Execution/Construction, Project Management and Inspection Team work and activities remotely from field Work Environment comprises at least one of the management's activities.

Interface number 6: In an aspect, Post Execution—Construction: Field post completion special features of the program/project management office.

In an aspect, post work/execution/construction, includes the capability to perform the following functions:
Pre-final and Final Inspections.
Final quantity measurements.
Commissioning and Turnover
Maintenance and Operations
The method, wherein said Post Execution/Construction, Project Management and Inspection Team work and activities remotely from field Work Environment comprises at least one of the management's activities.

Interface number 7: In an aspect, Post Execution—Construction: Office

Post completion special features of the program/project management office

In an aspect, post work/execution/construction, includes the capability to perform the following functions:
Commissioning and Turnover
Project Closeout
Maintenance and Operations
The method, wherein said post work Execution/Construction, Project Management and Inspection Team work and activities from an Office Work Environment comprises at least one of the management's activities

### CONCLUSION

This disclosed program provides a one-stop solution directed to the management profession to utilize as an applicable and complete computer program product that works on all methods and processes of the management requirements. With its standardized platforms and interfaces for all program and project users the embodiments provide standardized methods that carries specific processes and procedures to address several types of project delivery modules.

For construction industry as an exemplary example design-bid-build, design-build, public-private-partnership, construction-manager-general-contractor, and design-build-operate are the main contract procurements of the industry and this disclosed invention can operate according to the member's choice of these modules.

While on the general administrator's interface all typical management's activities can be utilized, in addition the system provides all needs to conduct the pre-project work or pre-construction needs.

After contract award, all pre-project/construction information and data will be migrated to an active project status, then the project administrator may continue setting up the project along with all new data and resources. Project specific interfaces users will carry on their typical project management or administration through the execution period towards completion and closeout. Such activities can be conducted through office base/work environment or remotely while away from the office, in the field or at the sources that is not limited to plants, vendors, suppliers or manufacturing premises.

This computer program was designed and built containing all necessary plans and forms required for the project and tight a member's (organization's) master database that allows for the organization to manage several projects of different types of delivery system and all at the same time. Member's function on each project may vary, the program/system allows for such differentiation and all are controlled during the early project setup. Such differentiation can be simply clarified as a member could be an owner on one project, a designer on another or a builder or quality manager on a third project and so on.

Based on the needs of each project, the system allows for an integration with a third party computer programs, as an example specific design software, time management programs and or any other type of program/project management software may be needed for the project. Such integration can be—after license permission and allowance—either direct or by means of a bypass all through the same interfaces.

As a conclusion, the program provides standardized platforms for all program and project users to utilize while conducting their day to day management works, allows for real time and seamless Communication on all project's aspects including technical deficiencies or Issues resolution on timely manner, control, minimize, mitigate and/or prevent project risk or claims. In addition, this invention expedites management processes and procedures with real time, accurate and factual information. It also provides several types and levels of reporting formats that is applicable across all tiers of an Organization, Program or project. It is sustainable and reduces the carbon-foot-print in several ways.

Based on what has been described and presented and depends on the level of provided information it should be clear that the schematics, diagrams, blocks and flowcharts were presented as exemplary examples to reflect the functionalities and performance of this disclosed invention. All presented data are clear enough to those individuals of the industry to understand the configuration, parts, modules, packages and elements of this disclosed invention. Components connectivity and the setup of all elements along with the sequence of this invention was clarified too. This invention is not limited in its application to the details and the components arrangements, the invention with other embodiments and of how being practiced or of being carried out in various ways, it can be presented in so many ways; what were presented in this invention is just to clarify in a direct and simple way the entire structure of the invention along with its specific modules and packages that provide a complete solution for the management industries regardless of the specific discipline. The phraseology and terminology used herein (in this disclosed invention) are for the purpose of providing easy and direct description of the invention parts/tiers, components, modules, packages and elements, such should not be regarded as limited.

This shall extend the limits of this invention way beyond what has been presented as examples only. So, the actual scope of the disclosed invention is what matters regardless of the way or ways it may be reproduced or reframed at. All presented data, information drawings, chart's illustrations in this invention is meant to fit as an example and model, and to be considered as model of conduct and model implementation. The idea, the sequence, and the specified patterns have more in depth information, industry professional may pick it up from these documents and reframe it in a way or another and these inventions shall be protected.

With this program (Construction Projects as an example) all project teams, designer, builder, owner, agencies, oversight, subs, suppliers, quality management, consultants, project and construction manager, vendors, fabricators, materials engineers, subcontractors and any other firm or stakeholder working on the project can utilize the solution without any interference with other organization and all can share the same common information that needed to be shared. Each organization can maintain their own privacy of their own documents and this invention provides the highest possible security for their documents. In other words, each organization (stakeholder) within the same project have their own private documents that classified as internal documents and not yet ready to be a project document. Still, organizations can keep it confidential or internal permanently or for temporary basis until its maturity time to be shared as a project document and/or can keep it confidential (internal) until the end of the project.

Thus, specific embodiments of a computer program/project management solution have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A computer-implemented product and method directed to the project management profession in an automated, integrated digital solutions presented in a computer program product, said solutions compromising:
three major tiers/parts, cloud with virtual and backup servers to host, processors to control the functionality of this program/project management system according to the pre-defined method;
a built-in master database management system compromises of several sectorial databases all integrated on common platform as a model of conduct environment for optimizing, providing complete and facilitating an automated management solution; wherein; exchanging (synchronizing) data through a server database;
a communication terminal interfaces integrated with set of computer-implemented products, systems and solutions that allow for plurality of users through plurality of terminals to conduct plurality of diversified tasks in a plurality of controlled work environment;
said project management methodologies are tied to a predefined and standardized processes and procedures for said automated program/project management system;
wherein an automated program/project management system that allow for a plurality of users representing plurality of organizations to perform multiple tasks through said plurality of terminals from an office or remote/field work environment in a pre-defined process with customizable template forms to;
exchange and synchronize data through a server database;
wherein an optimum using and aspect with a computing system to utilize in a, computing environment for optimizing, providing and facilitating a complete and automated management solutions, and
a program, system, method in an integrated said cloud with a virtual and backup server to host, processors to control the functionality of this program/project management system according to the pre-defined method and said built-master database in a said automated program/project management system within a cloud tied to server and built with a database of several sectors, integrated with third party interactive websites/systems and other software.

2. The computer-implemented product and method according to claim 1 that serves cloud, sub-clouds, servers, the master database, sub-databases, member's and project's specific websites further including;
a bidirectional synchronization of said data between used terminal among terminals, plurality via processor to the server and saved at said built-in master database to at least one additional computer system configured to carry out program functionalities and said bidirectional synchronization compromising;
a receiving data from day-to-day, project management office (PMO), project management of a specific project, storing data, retrieving data and deploying data.

3. The computer-implemented product and method according to claim 1 wherein said execution, construction, project specific, office and remote/field users, serve as an example for the project specific administrator, new project setup, new user setup, project uniform document filling systems and control are managed through a built-in master database;
wherein, an optimum using and aspect with a computing system to utilize in a, computing environment for optimizing, providing and facilitating a complete and automated management solution, and
a program, system, method in an integrating said cloud with virtual and backup servers to host, processors to control the functionality of this program/project management system according to the pre-defined method and said built-in master database in said automated program/project management system within a cloud tied to server and built with a database of several sectors, integration with third party interactive websites/systems and other software.

4. The computer-implemented product and method according to claim 1 includes terminals—interface—for general administrator, project administrator; project office and project remote/field users and an extra terminal interface for quick safety and crises management compromises:
five communication interfaces pre-set for a programmed computer system that provides a plurality of tasks built in a program and a project management solutions managing operations through a plurality of terminals;
a member's general administrator's Interface number 1;
a project's administrator's interface number 2;
a project users interface from office work environment number 3;
a project's users interface from remote/field work environment number 4;
a quick crises and emergency management interface number 5;
said computer-implemented product and method serves project specific users compromising:
office terminal users as project manager, safety manager, environmental manager, design manager, construction manager, quality manager, project controls manager, contracts manager, special discipline as right-of-way and toll managers or other specialty;
field and mobile terminal users of project specific users and smart phone terminal users.

5. A support program solutions computer-implemented products, systems and solutions directed to support and facilitate the program/project management implementation in an automated, integrated digital solutions presented in computer program products, said solutions compromising:
a pre-defined and standardized management processes and procedures;
a project bidding solution;
a drag and drop form developer;
a right of way acquisition and management solution;
a traffic management and control solution;
an administrative management solution;
a quality management solution;
a project controls solution;
a safety and crises management solutions;
a project completions and closeout solution;
a project as-built and acceptance solution;
a project commissioning and operations system;
said solutions and systems were provided to facilitate and optimize the functionality under all work phases including day-to-day operations and after award activities and to cover all management groups/areas it also compromises:
a pre-execution (construction);
during execution (construction);
a post completion;
and while in contract award phase further compromising;
a delegate administrative responsibilities to a project specific administrator to perform;
a develop project initial submittals;
a project schedule, project management plans including general project management plan, safety management plan, environmental management plan, SWPPP and/or WPCP plans, quality management plan, construction management plan, traffic management plan, and to continue setting up the project and stakeholders information, and
further includes subs and setup updates and identify member's and other stakeholders rule on the project.

6. The computer-implemented product and method according to claim 5 and under the pre-execution (construction) phase compromises:
a bidding system;
wherein, through the general administrator terminal, plurality of users utilizing organization's and PMO's databases to upload the new project's data and information, and;
a collect stored and previously saved data and information;
incorporation of the collect stored and previously saved data and information in in the new project requirements and;
extract initial bid information, subject for review and interaction;
wherein, said integrated results are subject for further verification, such generate bid documents;
form developer and editor;
wherein, general administrator and/or project administrator utilizing their specific terminals may utilize existing forms and template or;
edit and/or customize exiting forms and templates, or;
generate new specific forms;
wherein, the forms are automatically saved and ready to be utilized.

7. The computer-implemented product and method according to claim 5 under during execution (construction), compromises:
traffic management and control;
administrative management system;
quality management solutions;
project controls;
safety and crises management and reporting system;
said solutions and systems were provided to facilitate and optimize the functionality by executing computer executable process and procedure pre-loaded on the computer readable database to perform the mentioned acts.

8. The computer-implemented product and method according to claim 7 while in pre-execution (construction) phase compromises:
a bidding system;
wherein, at least one bid items is generated and documented, and
after bid opening, general administrator to upload other bids information and data for future references and bids.

9. The computer-implemented product and method according to claim 7 while in either pre-execution (construction) or during compromises:
a drag and drop form developer;
wherein, at least one from is edited and at least one form is generated.

10. The computer-implemented product and method according to claim 7 while in either pre-execution (construction) or during compromises:
a right-of-way acquisition and management solutions;
wherein a at least one property is scheduled; at least one property is processed and followed up;
at least one property is acquired, and
at least one property is delivered for construction.

11. The computer-implemented product and method according to claim 5 while in post completion phase compromises:
a project completion and closeout solutions;
project as-built and acceptance;
project commissioning and operations systems;
said solutions and systems were provided to facilitate and optimize the functionality by executing computer executable process and procedure pre-loaded on the computer readable database to perform the mentioned acts;
said method and system further compromises:
post execution (construction) with plant establishment, warrantee period, commissioning, operations and maintenance;
field post completion special features of the program/project management office. The method, wherein said post execution/construction, project management and inspection team work on activities remotely from field work environment compromises at least one of the management's activities;
post work execution/construction, includes the capability to perform the following functions;
pre-final and final inspections; final quantity measurements; commissioning and turn over to maintenance and operations;
post execution/construction: office post completion special features of the program/project management office;
post work execution/construction, includes the capability to perform the project closeout and final acceptance, and
the method, wherein said post work completion, project management and inspection team work and activities from an office or field's work environment compromises at least one of the management activities.

12. The computer-implemented product and method according to claim 11 compromises:
a traffic management and control systems;
wherein, traffic and closures management module provides the right tool for project's team in the office and the field to communicate and collaborate with the approving agencies and the law enforcement authorities. Such facilitates the real time monitoring and need for any closure and allows for adequate traffic management compliance;
at least one traffic management and/or traffic control report is generated, reviewed, approved and published further compromising:
a traffic handling plans
a closure planning;
a closure request, review and approval;
a closure implementation;
a closure reporting and performance measured;
communication and management on a real time, further compromising:
contractual acts based on closure implementation and performance, further compromising:
an update to traffic management plan;
a change order;
a revision to the approved traffic closure charts, and
further actions to be taken, documented and published.

13. The computer-implemented product and method according to claim 11 under administrative management system compromises:
a task assignments and to-do-lists;
time sheets;
new on-boarding individuals;
said solutions and systems were provided to facilitate and optimize the functionality by executing computer executable process and procedure pre-loaded on the computer readable database to perform the mentioned acts;
said method, while after contract award, provide work capabilities to perform the following functions by project administrator;
update project setup; update user's information and access privileges; generate, utilization reports and analysis; maintain and update the program/project management solutions; select, update and/or modify project forms and templates; project process and procedures; project's teams and resources; maintain and update project's information; assign users and their classifications; project permits; such as environmental permits; general construction permits; and/or any other specific permits; update project plans such as traffic handling and motorists information plans; communicate and seek support from member's project management office.

14. The computer-implemented product and method according to claim 13 wherein said after contract award and while during work execution/construction include the capability to perform the following functions by project's management, administration and project inspection teams from an office and field work environment, such compromises:
risk management, such identify risk, conduct risk analysis, quantitative and qualitative, plan risk responses and mitigation, communicate with project procurement team; generate risk reports and risk response, wherein
at least on risk is identified;
at least one risk mitigation plan is generated;
at least one risk monitoring report is generate;
at least one risk mitigation action is implemented and complete.

15. The computer-implemented product and method according to claim 13 compromises:
a new project onboarding individual;
a task assignments and time sheets, wherein
at least one new project employee data is uploaded and published, wherein
at least one time sheet is generated, reviewed and approved.

16. The computer-implemented product and method according to claim 13 compromises environmental and storm water management; such included water pollution prevention plans, inspection and verification, wherein
operations include plane development, implementation; maintain BMPs and provide data to amend, update and or/modify the initial plan as per the construction phases and changes, include actual field inspections, report compliance/non-compliance and all deficiencies;
a report performance data; permits tracking; frequent reports, in which, at least one management related activity is generated and complete.

17. The computer-implemented product and method according to claim 11 provide a total and complete quality management system classified as QE4S that complies with quality needs and requirements; economy and budget of the project; the safety; the sustainability; storm water/environmental aspects; and time schedule, said solution compromises:
a request for information;
a punch-list items;
a quality testing and records;
submittals;
a non-conformance reporting;
an inspection verification system;
a materials test results and analysis;
said solutions and systems were provided to facilitate and optimize the functionality by executing computer executable process and procedure pre-loaded on the computer readable database to perform the mentioned acts;
the method, wherein said during execution/construction, construction and quality management and inspection team work on activities from an office and/or remote/field work environments compromises at least one of the management activities;
the method, wherein during execution/construction, project management and inspection team work on activities remotely from field work environment compromises at least one of the management's activities, while most of the field's work activities are back and forth between office and field, wherein
is a risk based quality management program and said solution provides features for the F&t statistical analysis module and allow for quality improvement.

18. The computer-implemented product and method according to claim 17 compromises:
a punch list items system, wherein
in which at least one deficient item is generated, reviewed, approved and uploaded to the punch list for further corrective actions, compromise:
a follow-up and inspection on these deficiencies until the right corrective action been taken, documented, approved and closed out.

19. The computer-implemented product and method according to claim 17 compromises:
a quality testing and records, wherein
in which at least one quality testing report is generated, reviewed and approved, further compromising:
a quality testing reports analysis for final acceptance, wherein
reviewing, validating and implementing either the tolerances method or the F&t statistical analysis is used.

20. The computer-implemented product and method according to claim 17 compromises:
a construction and submittals management system, wherein
at least one of the construction planning, sequencing, submittal and/or a request for information is generated and proceed;
in which at least one submittal is generated, submitted, reviewed commented on and approved.

21. The computer-implemented product and method according to claim 17 compromises:
an inspection reporting and verification, wherein
during said execution/construction process reporting process and procedure feature provide specific modules for field workers to act on their tasks and to conduct technical and non-technical inspections and reporting; that is not limited to drainage, utilities, roadway and structure including all other specialty work disciplines the project includes;
at least one technical inspection report is generated, signed, reviewed and approved, compromising:
a chance to capture and document a deficient item but not qualified for a non-conformance report generation, and
is subject for further visits and more in depth inspections until corrective actions been taken and the issue is disposed with full compliance.

22. The computer-implemented product and process method according to claim 21 compromises:
a non-conformance reporting, wherein at least one non-conformance report is generated, reviewed and approved;
the capability of revisiting and re-inspecting on the deficient item for further corrective actions, documenting, and disposition;
disposition further comprises contractual deductive act, or to accept-as-is if fit for purpose.

23. The computer-implemented product and method according to claim 17 compromises:
a material testing results and analysis, wherein
materials verification, testing and acceptance compromises:
material receiving reports; materials placement reports; materials sampling reports; materials testing reports; quality control, quality assurance and/or an independent quality assurance features;
non-conformance reporting, testing and releases, at sources or at field work environment including plant and source certification features;
incorporated to control, verify and validate quality in an automated methodologies and at any time of the project, in which at least one material testing is conducted, report is generated, reviewed and approved;
the capability to generate and technical deficient issue or a non-conformance report;
further inspection and/or validation to the deficiency corrective action for final documentation and reporting;
said solutions and systems were provided to facilitate and optimize the functionality

24. The computer-implemented product process and method according to claim 23 further compromises:
material acceptance and releases; wherein; in which at least one material is inspected, reported, approved and released for installation;
tracking and reporting this material based on the contract requirements and the applicable laws and regulations.

25. The computer-implemented product and method according to claim 11 under project controls compromises:
a performance management;
a schedule progress and look ahead;
a pay estimates and progress payments;
said solutions and systems were provided to facilitate and optimize the functionality by executing computer executable process and procedure pre-loaded on the computer readable database to perform the mentioned acts;
said computer program-method further compromises:
a capability to perform functions by member's general administrator and other office teams;
the method, wherein said pre-execution/construction, pre-bid, project preparation work and activities compromises at least one of the management's activities;
a bidding and bid solicitation;
a link member's organization to preferred leads;
a develop and manage pre-bid qualifications;
perform business marketing and promotional efforts;
provide bidding solutions; for several types of procurement systems project bidding;
review bill of quantities; review statement of work; general bid bonding requirements; complete and submit bid; collecting data project preliminary schedule; inputting estimates; completing and submitting bid, wherein
said pre-execution/construction, bidding work and activities compromises at least one of the management activities.

26. The computer-implemented product and method according to claim 25 compromises:
a performance management, wherein
a general administrator's platform, a fit model for member's general administrator, project administrator and/or the project manager through computing environment to conduct performance evaluation on the project; the individuals; the subs and/or the progress of the project in all required aspects, in which at least one type of performance management report is generated, reviewed, approved and published;
improvement acts to be taken and further analysis shall be conducted and reported subject for more improvements.

27. The computer-implemented product and method according to claim 25 compromises:
schedule progress and look-ahead reporting, wherein
while in execution phase and under project's controls management, the method provides features and system to manage and update project schedules and allows for the management to allocate resources and plan for construction sequencing and work activities, in which
at least one schedule update and/or look-ahead reports and/or one daily work schedule are generated, reviewed, approved and published.

28. The computer-implemented product process and method according to claim 25 further compromises:
a pay estimates and progress payments and carrier over the results as declared in claim number 40; wherein; based on and as a result of the inspection reporting system during the work execution/construction phase, all payable work items are documented and automatically updated through the database, in which project financials are monitored on a real time and actual financial progress is recorded and documented, in which
at least one pay-estimate (progress payment report) is generated, reviewed, approved and processed.

29. The computer-implemented product and method according to claim 11 compromises:
a safety and crises management, wherein
safety, and crises and incident response and management module further includes a project specific-crises and emergency management for all project users. In this disclosed solutions the safety management is classified and categorized under health and safety and traffic safety including the law enforcement services and features, in which
at least one safety incident is communicated and managed on a real time;
at least one safety inspection report is generated, reviewed, published and acts upon;
at least one near miss report is generated and published, further compromises legal and/or administrative acts to be taken;
lessons learned report to be generated and recommended corrective actions to be implemented, and
project's safety plan is to be updated, reviewed, approved and published.

30. The computer-implemented product and method according to claim 11 compromises:
an automated project completion and closeout solution, wherein
the computer-implemented product and process method automatically collect all related project documents and records;
facilitate automated documents and records review and approval;
links all stored data to the contractual closeout requirements;
provides just-in-time close out compliance reports in which at least one major component of a project is completed, documents and records were collected, reviewed and approved,
further compromising closeout progress reporting, and
follow-up on closeout actions and dispute items until final closeout and acceptance.

31. The computer-implemented product and method according to claim 11 compromises:
a project as-built and acceptance systems, wherein
at least one as-built red-line is documented on a plan sheet, reviewed and approved. such further compromises, communicating these redline plan sheets with the designers to generate the final as-built drawings for review and approval.

32. The computer-implemented product and method according to claim 11 compromises:
a project commissioning and operations, wherein
at least one major component of a project is commissioned and approved;
further compromises:
facilitating operations procedures and requirements;
in which a new project or partial sub-project is to be set by the organizational general administrator.

33. The computer-implemented product and method according to claim 17 compromises:
a design management and request for information, wherein
while in the execution/construction phase of the project; after publishing the approved project plans ready for construction, and
said solutions and systems were provided to facilitate and optimize the functionality in which at least one request for information is generated, reviewed responded upon, validated and approved.

34. The computer-implemented product and method according to claim 33 compromises:
a notice of design change, wherein
at least one notice of design change note is generated, reviewed and approved;
further compromising:
a follow-up with design team until the new design is complete, reviewed approved and published;
document, analyze and provide schedule corrective action to prevent schedule impacts and delays on the project.

35. The computer-implemented product and method integrate the functionality of the additional computer implemented groups and from all terminals, comprising:
a project management office solutions compromising:
components, functionalities and relations for functionality during a pre-bidding process;
an initial setup of the project, a project procurement type and a member's role of a bidding process; wherein said program/project management office provides capabilities of providing full support during project execution of project plans, templates, forms, tables and all other technical support;
said program/project management office provides capabilities of facilitating full support after project completion of project punch-list, closeout, performance and technical lessons learned that addresses the general project management to facilitate and conduct performance management measures;
a progress monitoring and tracking;
performance measurements for project, materials and individual;
an auditing to conduct and facilitate project training, and
track project completion and closeout on a project progress basis.

36. The computer-implemented product and method according to claim 35 wherein the project management office and said solutions and systems were provided to facilitate and optimize the functionality by executing computer executable process and procedure pre-loaded on the computer readable database to perform the mentioned acts;
while in a pre-bid phase further includes a project setup with a general and/or specific—project administrator platforms with a project procurement type configures to choose and select a project's procurement packages based on its delivery type;
a rule on the project configured to select a member's rule package on the project as an owner, a builder, a designer, a quality manager, an oversight and a consultant;
a project initial information configures to setup a project initial information including general data and said project's specifics from a request for project proposal (RFP), and insurance, bid-bonds configured to procure and select insurance and bonds requirements that track and report said project's performance;
project preparation, project initiation, planning and initial project setup. Such is not limited to create, modify or update project management plans templates but extends to collect project requirements and to specify project's scope, and
initiate and develop project's preliminary schedule and estimate and allocate budgets, initiate work breakdown structure, specify project activities and estimate resources and durations.

37. The computer-implemented product and method according to claim 35 under project management office functionality and relations compromises:
a meetings management solution;
a reporting systems;
a change management solution;
an auditing system;
a uniform filing system, wherein
said solutions and systems were provided to facilitate and optimize the functionality by executing computer executable process and procedure pre-loaded on the computer readable database to perform the mentioned acts.

38. The computer-implemented product and method according to claim 35 compromises:
a meetings management, wherein;
while in day-to-day operations, either pre-award or during execution (construction) include the capability to perform the functions compromises:
perform meeting management; develop, assign and act on tasks and assignments; communicate through typical digital emails and messaging; business collaboration; transmittals and correspondences; provide the features to manage business processes; customize business needs to preferred formats; link member's organization to preferred leads; manage-mail-in mail-out; customize routing of business process; access organization's projects; monitor and track performance; provide required back-up for organization's projects; track and record project's lessons learned, wherein
said day-to-day management work and activities compromises at least one of the management's day-to-day activities is developed, generated, recorded and complete, in which at least one meeting request is generated and published;
documenting and reporting meting minutes and actions taken;
generating specific action items for specific individuals, due on specific date, and
follow-up on plurality of tasks, plurality of action items and further reporting results and publishing.

39. The computer-implemented product and method according to claim 35 compromises:
a reporting system, wherein
at least one technical or non-technical report is generated, reviewed and approved such further compromises the at least one technical or non-technical report.

40. The computer-implemented product and method according to claim 11 compromises:
contracts and change management solution, wherein;
said contracts and procurement management; change management; directive letters; stop work orders; validation correspondences; differing site conditions; liquidated damages; labor compliance; disputes and potential claims management; complaints and public feedback; sub-contracts are tracked and managed through the automated data feed from an office and field work environments in which at least one potential change order is generated, reviewed and submitted for further contractual actions;
at least one contractual change based on the situation and the type of pay agreement;
otherwise will remain as a potential change for tracking purposes only until further actions.

41. The computer-implemented product and method according to claim 35 compromises:
an auditing system, wherein
at least one auditing for at least one type of the management categories is conducted, reported, reviewed, analyzed and provided the recommended improvement actions.

42. The computer-implemented product and method according to claim 35 compromises:
a uniform filing system, wherein
all project's files and folders are categorized in a uniform filing system that is automated and standardized;
such filing system provides the fit for use module on all management disciplines and allows for accurate documents and records repository;
said repository is accessible on line;
open to all users based on their access privilege;
said uniform filing system contains all necessary categories as per the agencies pre-approved document management systems, and
said document control system is subject for additions and editing within the pre-set and pre-defined filling categories disclosed in this program method.

43. The computer-implemented product and method according to claim 35 under project management office work phases compromises:
a support organizational general administrator during all day-to-day operations;
a pre-bid operations and setting up new projects;
providing updated information that supports bidding process;
allow for advance project setup and maintain and update project data;
supports project completion and closeout;
providing standardized and customizable process and procedure through project acceptance, commissioning and operation, and
said solutions and systems were provided to facilitate and optimize the functionality by executing computer executable process and procedure pre-loaded on the computer readable database to perform the mentioned acts.
